(19) United States
(12) Patent Application Publication
(10) Pub. No.: US 2009/0307187 A1
(43) Pub. Date: Dec. 10, 2009

(54) Tree automata based methods for obtaining answers to queries of semi-structured data stored in a database environment

(76) Inventors: Amir Averbuch, Jaffa (IL); Shachar Harussi, Kfar Oranim (IL)

Correspondence Address: Amir, 6 Hazedef street, Tel Aviv Yaffo, 68034, omitted

(21) Appl. No.: 12/395,968

(22) Filed: Mar. 2, 2009

Related U.S. Application Data
(60) Provisional application No. 61/032,109, filed on Feb. 28, 2008.

(51) Int. Cl. G06F 17/30

(52) U.S. Cl. 707/2; 707/5; 707/E17.005; 707/E17.017

(57) ABSTRACT

Methods for efficiently obtaining answers to queries in a database (DB) environment include forming tree automata (TA), processing semi-structured data using the TA to provide indexed data, pruning the indexed data to obtain pruned data and performing a join operation to join either the pruned data or the semi-structured data to provide the answers. The queries relate to data stored as semi-structured data. In some embodiments, the TA is unordered.

### CROSS REFERENCE TO RELATED APPLICATIONS

This application claims the benefit of U.S. Provisional patent application No. 61/032,109 filed Feb. 28, 2008, which is incorporated herein by reference in its entirety.

### FIELD OF THE INVENTION

The invention relates in general to databases and more particularly to semi-structured data processing using tree automata.

### BACKGROUND OF THE INVENTION

A database (DB) is a collection of information organized in a structured way so that the information can easily be retrieved, managed and updated. The data in a DB is organized according to a model. There are several such models. The dominant models, such as relational models, are structured. We call a DB with a structured model a structured DB. A structured DB contains a collection of database files. Each DB file is a collection of records. A record is a set of fields. A field is a content of a certain data type: numeric, character, logic, date, etc. A DB schema is a description in a formal language of this structure. The DB schema defines the files, the fields in each file and the relationships between fields and files in the DB. A structured DB has a single known schema. The term structured DB refers to any DB model: relational, native, object oriented etc. that stores data as described in this paragraph. A relational DB is an example of a structured DB.

Query languages enable to retrieve data from a specific file or from multiple related file in a database. Retrieval requests from a DB are expressed by a query language. Each type of a data model such as relational, semi-structured, etc. has its own set of query languages. The common standard relational query language is SQL.

### Indexing and Join

Database indexes speed up data retrieval. They are much the same as book indexes, providing the database with quick jump points on where to find the full reference. The indexes are additional data structures that store references to the actual records. For example, an index can be a hash table that stores all the records references in buckets, sorted by their values in a specific field. When the user requests to retrieve all the records that contain a field with this value then the DB retrieves the requested records by first retrieving the references from the hash table and then retrieving the actual records from the file one by one. It is faster than performing a full traverse (scan) of all the file records.

When data is retrieved from multiple related files, the DB join mechanism combines the records from these DB files. It creates a joined records set and returns it to the user. A join mechanism must efficiently join the records from different files according to a join criterion that relates the multiple DB files. Efficient indexing and join operations extract a minimal number of records from the DB files.

### Semi-Structured Data

A labeled graph is a pair (G, label) of the graph G and of a label function. The graph G is the pair (V, E) where V is a set of nodes and E is a set of edges that connect them. A node up is called a parent of a node vc if there is an edge (up, vc) that connects between them. The node vc is called a child of node up. The label function maps each node to a label.

A semi-structured model is a database model that presents data through a labeled graph. In this model, there is no separation between the data and the schema, and the amount of graph structure used depends on the usage goals.

The nodes in the semi-structured model store the data. The nodes in the graph model are equivalent to records and fields in the structured model. They are equivalent to fields because they store the data itself. They are equivalent to records because they refer to a collection of fields—the node children. Thus, instead of having a fixed records set, the representation is done by a graph. Instead of a single schema as in a structured DB, the DB schema of a semi-structured model describes a collection of labeled graphs which the DB can accept. This enables the flexibility of a semi-structured data query.

In order to support this flexibility, the semi-structured data query languages are richer than structured model query languages. They express two criteria types: the graph structure and the stored data in the graph nodes. The data criteria are the same as in structured DB query languages. The data criteria describe a Boolean expression of the data values. The structural criteria express relations between nodes in the graph structure. There are several structural relation types. The most common are: 1. parent-child (denoted hereinafter as P-C): If up is a parent of node vc than (vp, vc) has a parent-child relation; 2. ancestor-descendant (denoted hereinafter as A-D): if node va is a parent of node vd or, in recursion, if nodes (vc, vd) has an A-D relation, where node vc is a child of node va, then nodes (va, vd) have an ancestor—descendant relation.

Semi-structured query languages are not standardized. Recently, a “twig-pattern” was suggested as a formal representation for the structural criteria of semi-structured languages, see e.g. N. Bruno, N. Koudas, and D. Srivastava, “Holistic twig joins: optimal XML pattern matching”, Proceedings of SIGMOD, 2002 (hereinafter “BKS”). A twig pattern has a labeled-tree form. XML stands for eXtensible Markup Language. A labeled-tree is the same as labeled graph except the graph has a form of a “tree”. A tree is a graph with the following constraints: all nodes but one have a single parent. The exceptional node is called a root and has no parents. A node without children is called a leaf. The labels of a twig tree are a subset of the queried semi-structured data labels. The twig pattern also maps each edge to a nodes-relation type: A-D or P-C. The twig-pattern can express the structural portion of queries which are written in one of many semi-structured query languages. Given a twig pattern Q and semi-structured data D, a match of Q in D is identified by a mapping from nodes in Q to nodes in D, such that the P-C and A-D relations between query nodes are satisfied by the corresponding D nodes. An “answer” to twig pattern Q with n nodes can be represented as an n-ary relation where each tuple (d₁, . . . , dₙ) consists of D nodes that identify a distinct match of Q in D.

There is a common way (see BKS) to store semi-structured data in a structured DB. Each node in the semi-structured model is considered to be a record. The record contains fields that encode the location of the node in the tree. When extracting two records from a file, the A-D and P-C relations can be determined for these records by the encoded location. Many such encodings exist. The records are either split into files according to node labels or stored in a single file and contain a field with the node label. The order of the records in the file is determined by some top-down or bottom-up traversal order: pre-order, post-order, etc. Each node-record has identification (ID) which is the order in which the traversal takes place.

In view of the inefficiencies in retrieving semi-structured data and getting answers to queries on such data in a database environment, there is a need for and it would be advantageous to have methods that perform such actions more efficiently.

### Automata and Languages

In this invention, the twig-pattern inputs are being formalized as automata. In this section we give the background that is need for the understanding of this formalization. We explain three concepts: regular expression, Finite State Automata (FSA) and Tree Automata (TA).

A regular expression is an expression that describes a set of strings. They are usually used to give a concise description of a set, without having to list all elements. Regular expressions consist of constants and operators that denote sets of strings and operations over these sets, respectively. Given a finite alphabet Σ the following constants are defined: Ø (empty set), ε (empty string) denoting a string with no characters, a denoting a character in the language. The following operations are defined: concatenation RS denoting the set {αβ|α in R and β in S}. alternation R|S denoting the set union of R and S and R* denoting the smallest superset of R that contains ε and is closed under string concatenation. This is the set of all strings that can be made by concatenating zero or more strings in R. For example, {“ab”, “c”}*={ε, “ab”, “c”, “abab”, “abc”, “cab”, “cc”, “ababab”, “abcab”, . . . }. Examples: a|b* denotes {ε, a, b, bb, bbb, . . . }. (a|b)* denotes the set of all strings with no symbols other than a and b, including the empty string: {ε, a, b, aa, ab, ba, bb, aaa, . . . }.

Finite State Automata supply an alternative way to describe a set of strings. The input to a finite state automaton is a string of input symbols. For each input symbol, the automaton performs a transition to a state given by a transition function which is designated inside the FSA. The transition updates the current state of the automaton. When the last input symbol is received then the automaton either accepts or rejects the string depending on whether the current state is an accepting or a non-accepting state of the automaton. This way, the automaton recognizes a specific collection of strings.

More formally, FSA is a tuple (Σ, Q, q₀, δ, F), where: Σ is the input alphabet (a finite, non-empty set of symbols); Q is a finite non-empty set of states; q₀ is an initial state which is an element of Q; δ is the state-transition function from a source state and a symbol into a target state and F is a subset of Q of an accepting states.

Tree Automata describe sets of trees. A bottom-up TA that process trees from the “bottom” of the tree, which is in the tree leafs, to the “top” of the tree that is the root. An input to a bottom-up TA is a labeled tree whose labels are the input symbols. It traverses the tree from leafs to the root. The TA annotates state to each node, according to a transition function. The TA makes a transition from the states, which were annotated to the children node and from the node label to a state given by the transition function. When the root state is reached, it either accepts or rejects the tree depending on whether the root state is in an accepting or a not accepting state. This way, the TA describes a specific set of trees.

More formally, a bottom-up finite tree automaton over a finite state F is defined by: (Q, Σ, F, δ) where Q is a set of states, Σ is a final set of input symbols, F is a subset of final states, and δ is a set of transition rules, which rewrite rules from a string, composed from the children states, to a parent state. Thus, the state of a node is deduced from the states of its children. There is no initial state but the transition rules for constant symbols (leaves) can be considered as initial states. The tree is accepted if the state at the root is an accepting state.

There are two types of bottom-up TA: “ranked trees” and “unranked trees”. The difference is in the transition function. Ranked trees have a finite set of children for each parent. Ranked tree transitions are for a finite set of children states—one for each node. A node in an unranked tree can have any number of children. Therefore, an unranked TA transition must express varying number of states. In order to express this condition, the transition is extended by regular expressions. The children of a transition are described by a regular expression over the automaton states. The transition is made if a string, which is composed of reachable children states, is accepted by the transition regular expression. A run is a mapping from tree vertices to their annotated states.

### SUMMARY OF THE INVENTION

The invention discloses techniques that speed up retrieval of semi-structured data from a database. To achieve this, the invention uses two fundamental structured DB operations: indexing and join. In this description, “joining” means performing a join operation. The invention provides methods to efficiently perform indexing and join for semi-structured models. The main advantage of a semi-structured model is its flexible format for data exchange between different types of DBs. The primary trade-off being made in using a semi-structured model is that queries cannot be answered efficiently as in a structured DB. The invention aids to eliminate this tradeoff by speeding up a query processing.

Answers to queries in a database environment are obtained very efficiently by processing twig-patterns and by performing holistic indexing and/or holistic join operations on the semi-structured data based on unordered twig-patterns. The queries may be received from any client or application, for example from a computer program, a database client, a web browser, a web service. etc. The semi-structed data may be stored in any known type of database, for example a relational DB, a native DB, a distributed DB, etc. The answers are returned to the client or application which submitted the query.

The pattern processing is performed over semi-structured data modeled as a tree (i.e. “tree-structured data”). XML is an example for such tree-structured data. In order to utilize the advantages of a structured DB and of a semi-structured DB, we store semi-structured data in a structured DB. In this way, the data retrieval according to a data criterion is efficient because the data is structured, and the format is flexible because it has a semi-structure model. What is missing in known methods is the ability to efficiently retrieve data according to structural criteria. This ability is provided by the invention and enables to process semi-structured queries efficiently from a structured DB.

The semi-structured data schema and query in this invention are modeled by tree-automata. The invention presents the first application of TA to indexing and join operations on semi-structured data stored in a structured DB. The invention models all the components of the semi-structured data, i.e. twig-pattern, data and schema, as tree automata. The TA processes ordered trees.

A new tree automata version is developed of a bottom-up unranked TA for unordered trees. Unordered trees are trees in which the order of node children has no meaning. We call these automata Unordered Unranked TA (denoted hereinafter as UUTA). Hereinafter the general TA term refers to a UUTA.

The join and indexing operations share a common primitive operation which is a selection of node records from the semi-structured data. These node records match nodes in the twig-pattern. We use a holistic selection operation on the on trees, which selects data nodes that match nodes in a twig pattern only if these selected data nodes are part of a whole twig answer. The holistic selection means that the all the twig-pattern constraints are checked in the same processing phase. The holistic selection is different from first selecting nodes in each P-C or A-D relation and then joining the results. The holistic selection is also different from selecting nodes in each separate path of the twig-pattern and then joining the partial-answers.

The known TA have the ability to perform a holistic selection operation on trees by using Selecting Tree Automaton (STA), see e.g. C. Koch “Efficient Processing of Expressive Node-Selecting Queries on XML Data in Secondary Storage: A Tree Automata-based Approach”. VLDB pages 249-260, 2003. A STA is a tree automaton which is extended with a set of selecting states. The selecting states tell the tree automaton which tree nodes to select. Nodes annotated by selecting states in the automaton run are selected and returned as output. The performing of a holistic selection operation on trees using an STA is referred to hereinafter as STA(T).

In a DB context, the semi-structured data tree structure can be too large to be modeled by the machine internal memory. Therefore we use TA as a compact description of the tree structure. In this invention, we develop a new holistic select operation that selects states in a TA. The data nodes derived by the TA states comprise a complete twig-pattern answer in one of the trees that the TA describes. The new holistic operation uses a STA. The performing of a holistic selection operation on a tree automaton A using a STA is referred to hereinafter as STA(A).

The holistic selection checks the twig-pattern constraints on the TA instead of on the tree. This operation enables an accurate extraction of records from the DB files. This accuracy in record extraction is what makes the operation extremely efficient.

According to the invention, there is provided a computer implented method for obtaining answers to queries in a database environment, comprising the steps of: forming tree automata; processing semi-structured data stored in a database the processing based on the TA to provide indexed data; pruning the indexed data to obtain pruned data; and joining either the pruned data or the semi-structured data to provide the answers to the queries.

According to the invention, there is provided a computer implented method for obtaining answers to queries in a database environment, comprising the steps of forming tree automata and using the TA, joining semi-structured data stored in a database to provide the answers to the queries.

### BRIEF DESCRIPTION OF THE DRAWINGS

The invention is herein described, by way of example only, with reference to the accompanying drawings, wherein:

FIG. 1 is a flow chart showing the main steps in a method of the invention;

FIG. 2 is a flow chart showing details of steps of FIG. 1;

FIG. 3 illustrates a twig pattern using a graph;

FIG. 4 illustrates the indexing operation;

FIG. 5 describes the flow of the holistic selection operation on trees;

FIG. 6 is an illustration of the FSA;

FIG. 7 is an example of a semi-structured data in a tree from;

FIG. 8 illustrates the bottom-up run of the schema-UUTA;

FIG. 9 illustrates the top-down run of the FSA in FIG. 6 on the run in FIG. 8 and the data in FIG. 7;

FIG. 10 describes the flow of the flow of the holistic selection operation on tree automata;

FIG. 11 illustrates the selecting FSA that is constructed from the twig-TA of the pattern in FIG. 3;

FIG. 12 illustrates of the intersected FSA;

FIG. 13 illustrates the join operation flow;

FIG. 14 illustrates semi-structured data for the join running example;

FIG. 15 details the twig-pattern used for the join running example;

FIG. 16 details construct partial solutions algorithm in the join module;

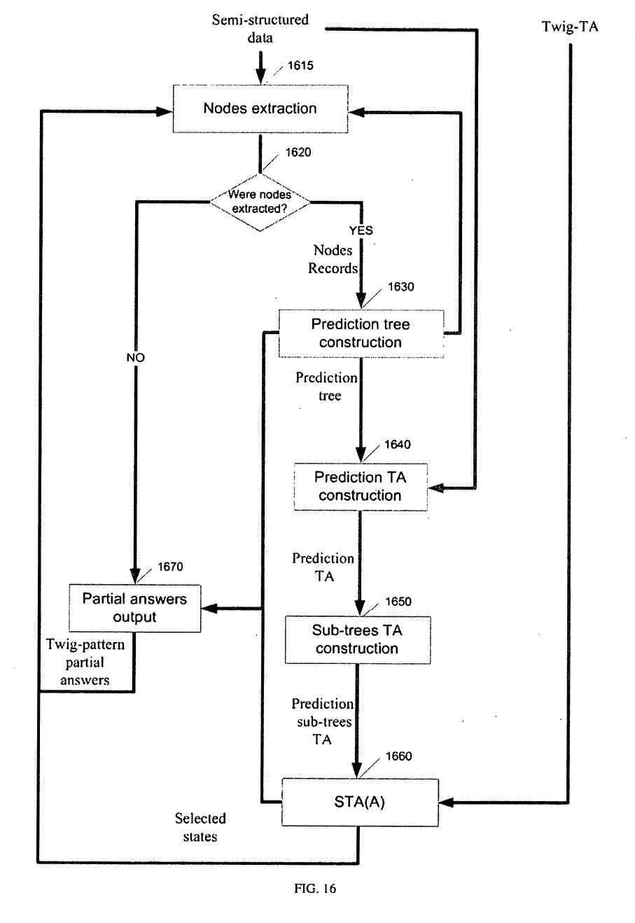

FIG. 17 details a prediction-tree construction from semi-structure data in FIG. 15;

FIG. 18 describes the FSA which is constructed from the twig TA constructed from the twig pattern in FIG. 15;

FIG. 19 describes the FSA which is constructed from the prediction TA in the example;

FIG. 20 gives details of the FSA which is constructed from the intersection of the twig TA constructed from the twig pattern in FIG. 15 and the prediction TA in the example;

FIG. 21 illustrates the run of the join algorithm on the data in FIG. 14 with the twig-pattern in FIG. 15;

FIG. 22 compares the performance of the TwigTA, TwigStack and iTwigJoin algorithms;

FIG. 23 illustrates an architecture of a typical system that implements the methods and algorithms of the invention.

### DETAILED DESCRIPTION OF THE INVENTION

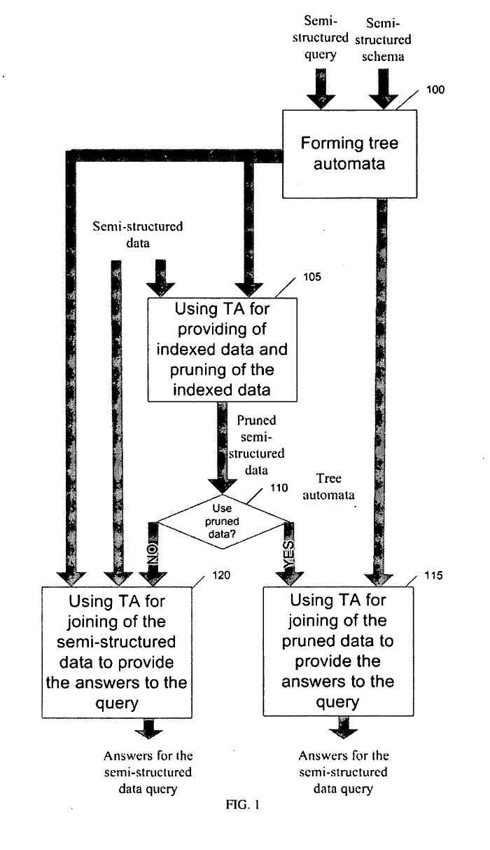

The main steps of the twig pattern processing are shown in the flow chart in FIG. 1. The processing operation is divided into three parts: preprocessing, indexing and join. The algorithm forms tree automata in a preprocesing step 100 using as inputs a semi-structured query and a semi-structured schema, The formed TA are input to both indexing and join operations.

An index is constructed and operated in step 105. The construction and operation include processing semi-structured data using the TA to provide indexed data and pruning the indexed data to obtain pruned data. In steps 115 and 120, the TA is used to join either the pruned data (step 115) or the input semi-structured data (step 120) in order to provide answers for the semi-structured queries. Step 110 checks if the join receives the pruned data as input. When the join operates without the index, it receives the semi-structured data as input.

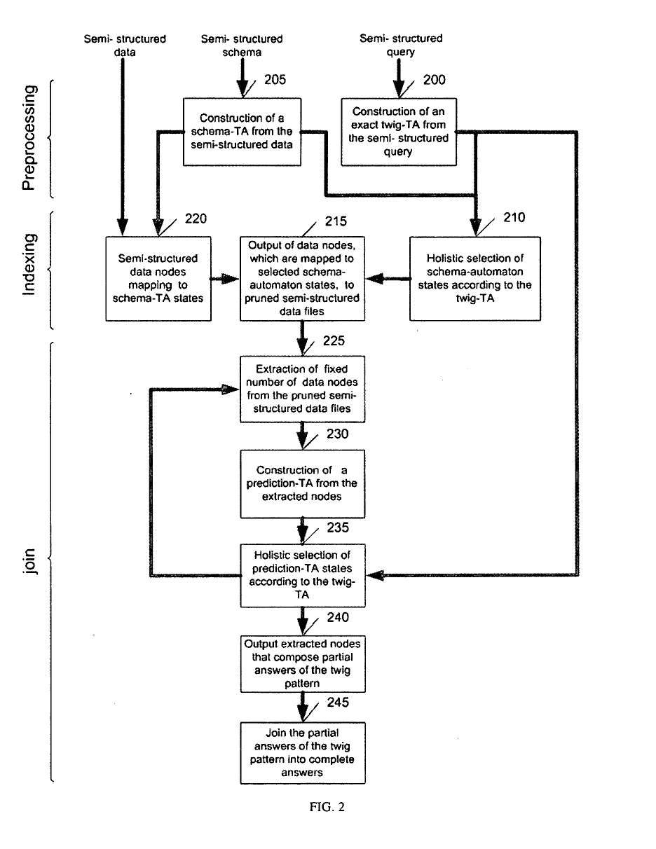

The flow chart in FIG. 2 provides further details of the steps in FIG. 1. The preprocessing part (step 100 in FIG. 1) includes two sub-steps: construction of a twig-TA from the semi-structured query (step 200) and construction of an schema-automaton from the semi-structured schema (step 205). The construction of a twig-TA is a semi-structured query input. Initially, step 205 forms a twig-pattern that defines the structural part of the query. Methods of forming a twig-pattern from a semi-structured query are well known, see e.g. S. Amer-Yahia, S. Cho, L. V. S. Lakshmanan, and D. Srivastava, Minimization of tree pattern queries, In Proc. of SIGMOD, Pages 497-508, 2001.

The indexing operation (steps 210-220) has two phases: offline and online. The offline phase (step 220) constructs the index as follows: it runs a schema-TA on the semi-structured data and maps data nodes to schema-automaton states that annotate the semi-structured data. This mapping is the index. The offline phase is done once. The online phase (steps 210 and 215) prunes the data according to the twig-TA. The online phase performs a holistic selection operation on the schema TA (step 210) and selects schema TA states which derive data nodes that match the twig-pattern. Then, step 215 prunes the indexed data nodes according to the selected schema TA states. Step 215 outputs to DB files the semi-structured data nodes mapped by the index to the selected schema TA states.

The join operation (steps 225-245) extracts iteratively a fixed number of data nodes from the pruned DB files (step 225). Then, the join operation constructs a prediction-automaton from these fixed number of extracted nodes (step 230). This prediction-automaton predicts the entire tree structure of the data. Next, the join performs the holistic select operation and selects prediction-automaton states that derive semi-structured data nodes which compose the twig-pattern. (step 235). Steps 210 and 235 perform the same STA(A) operation. Finally, the join operation outputs paths of data nodes which were derived by the selected prediction-automaton states (step 240). The output paths are partial answers in the twig-pattern. The join operation sorts the paths and joins them into answers (step 245). The answers are a set of tuples. Each tuple (d₁, . . . , dₙ) consists of database node records that identify a distinct match of a twig-pattern in the semi-structured data.

Each of the steps in FIG. 2 are now explained in enabling detail.

### Schema Construction (Step 205)

Schemas of semi-structured data, which have a tree data model, can be represented as unranked TA (see M. Murata, D. Lee, M. Mani: “Taxonomy of XML Schema Languages Using Formal Language Theory. Extreme Markup Languages”, pages 153-166, 2001). The existing TA processes ordered trees. Herein, we suggest a new version of unranked TA for unordered trees. Unordered trees are trees in which the order of nodes children have no meaning. We call this version “bottom-up UUTA”. Hereinafter, “TA” is used to mean “UUTA”. The UUTA structure resembles a TA with the structure (Q, Σ, F, δ), but the transition function is different. Each transition is from a set of children states and a parent label to a parent state. The UUTA run generates transitions for reachable children states, one per child, to a parent state. Although the transition children sets of states are finite, the processed tree is unranked because all the children with the same state contribute a single state to the transition.

The input schema is represented as an unranked TA. We construct here a UUTA that recognizes, without considering the order, the same trees as the input unranked TA. The UUTA construction uses the same states while the transitions are changed. The algorithm constructs from each unranked TA transition a set of UUTA transitions. Each transition contains a different set of children states that can be expressed by the regular expression of the unranked TA. The following pseudo code, called “Construct-UUTA function”, describes this construction:

```
Construct-UUTA ( unranked TA : (Qᵢₙ, Σᵢₙ, Fᵢₙ, δᵢₙ) )
Output: UUTA : (Qₒᵤₜ, Σₒᵤₜ, Fₒᵤₜ, δₒᵤₜ)
  Qₒᵤₜ ← Qᵢₙ,
  Σₒᵤₜ ← Σᵢₙ,
  Fₒᵤₜ ← Fᵢₙ
  For regular expression transition δᵢₙ (r,a)= q do:
    For all set s in Construct(r) // see table 2.
      Add transition δₒᵤₜ (s,a)= q
```

The Construct-UUTA function calls the Construct recursive function. The Construct function constructs the sets of states from regular sub-expressions recursively according to the operator type. For simplicity, we assume that each regular expression operator operates on at most two sub-expressions. We denote these sub-expressions as Left (L) and Right (R).

```
Construct (regular expression R.)
Output: set of symbols sets S.
  Operation ← The next operation of the regular expression
  Switch (Operation):
```

| | |
|---|---|
| Case symbol: | return a set that contains a single set with this |
| | symbol: |
| Case ‘\|’: | return union of Construct (L) and Construct (R); |
| Case ‘&’: | return union of unions of all sets in Construct (L) |
| | with all the sets in Construct (R); |
| Case ‘+’: | return all the subsets of Construct (L) |
| Case ‘*’: | return all the subsets of Construct (L) plus the empty |
| | set |

Example for the operation of the Construct function described above: for the TA transition δ(‘(qₐ|q_{b})*&q_{c}’,a)=q_{d}, we build the following UUTA transitions: δ({qₐ,q_{c}}, a)=q_{d}, δ({q_{b},q_{c}},a)=q_{d} and δ({q_{c}},a)=q_{d}. The following table shows how the sets of symbols are constructed from the regular expression ‘(qₐ|q_{b})*&q_{c} ’ of the transition. Each row describes one recursion step the operator type. The state sets inputs of the left and right sub-expression and the returned set of states.

| Type | Left | Right | Return |
|---|---|---|---|
| & | {qₐ}, {q_{b}}, { } | {q_{c}} | {qₐ, q_{c}}, {q_{b}, q_{c}}, {q_{c}} |
| Symbol | q_{c} | | {q_{c}} |
| * | {qₐ}, {q_{b}} | | {qₐ}, {q_{b}}, { } |
| \| | {qₐ} | {q_{b}} | {qₐ}, {q_{b}} |
| Symbol | q_{b} | | {q_{b}} |
| Symbol | qₐ | | {qₐ} |

### Twig TA Construction (Step 200)

A twig query is defined as (T, label, type) where T is the tree T=(V,E), the label function maps each node to a label in Σ_{twig} and the type function maps each edge to its nodes-relation type. The Twig UUTA is the tuple (Q_{twig}, Σ_{twig}, F_{twig}, δ_{twig}). Each node v is mapped into two states: qᵥ, and quᵥ, in Q_{twig}. The root of the twig pattern has no label. We denote it with the special label ⊥. The final state is a root state denoted q^{⊥}.

The Twig TA Construction algorithm iterates over the nodes and edges of the twig tree as follows:

1) For each node v, it determines the subset of children V_{descendant} that are connected to v in an A-D relation. Each subset V_{descendant}⊂V_{descendant} contributes a transition δ_{twig}(S,label(v))=qᵥ where each child uεS contributes state

$$\{ \begin{matrix}{qu}_{u} & u ∈ {V}_{descendant}^{′} \\ {q}_{u} & otherwise\end{matrix}$$

to S. These transitions guarantee that if all the children and descendants states are reached then the parent state is reached. We construct a transition for each subset V_{descendant}⊂V_{descendant} because child is also a descendant.
2). For each edge (v,u) with an A-D relation and for each label aεΣ_{twig}, two additional transitions are added: δ_{twig}((qᵤ),a)=quᵤ and δ_{twig}((quᵤ),a)=quᵤ. These rules ensure that parent node will accept its descendants.

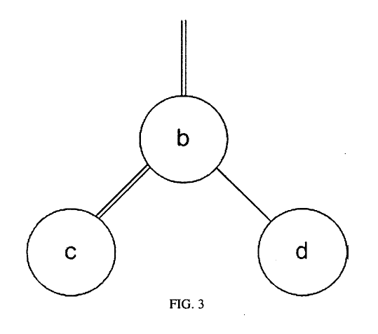

FIG. 3 describes a twig pattern. The twig-pattern tree maps each symbol to a node. Nodes that have relationships are connected with an edge. P-C and A-D edges are denoted by a single line and a double line, respectively The UUTA that is constructed from the twig query (Q_{twig}, Σ_{twig}, F_{twig}, δ_{twig}) where Q_{twig}={q_{⊥}, q_{b}, qu_{b}, q_{c}, qu_{c}q_{d}}, Σ_{twig}={⊥, b, c, d} and F_{twig}={q^{⊥}}. The twig pattern root node is denoted by symbol ⊥. The following transitions are constructed from the twig pattern nodes:

δ_{twig}({ },d)=q_{d}, δ_{twig}({ },c)=q_{c}, δ_{twig}({q_{c},q_{d}},b)=q_{b}, δ_{twig}({qu_{c},q_{d}},b)=q_{b}, δ_{twig}({q_{b}},⊥)=q_{⊥}, δ_{twig}({qu_{b}},⊥)=q^{⊥}.
For each a εΣ_{twig}, the flowing transitions are constructed from the twig pattern edges:
δ_{twig}({q_{c}},α)=qu_{c}, δ_{twig}({qu_{c}},α)=qu_{c}, δ_{twig}({q_{b}},α)=qu_{b}, δ_{twig}({qu_{b}},α)=qu_{b}.

### Index Processing (Step 105)

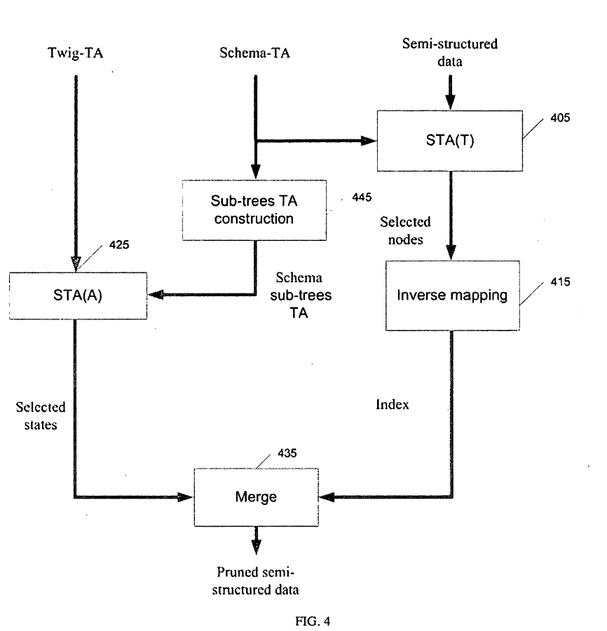

FIG. 4 describes the index processing in step 105 of FIG. 1 and steps 210-220 in FIG. 2. The indexing processing has two phases: offline and online. The offline phase receives the semi-structured data and the schema-TA. The construction of these inputs is described in FIG. 2.

The offline operation in step 220 is described in further detail in steps 405 and 415. The offline operation maps the schema-TA states to semi-structured data node records. A record of a node v is mapped to a state schema-TA q if it is reached by q in a bottom up run. However, this condition is not sufficiently accurate, because node v could be reached by more than one state. A state identifies the sub-tree rooted in v. It does not consider which TA states are reached by nodes in a top-down path from the root to node v.

Step 405 represents the STA (T) operation that maps the data nodes to relevant schema-TA states according to bottom-up and top-down considerations. The TA can only decide if a tree T is either accepted or not accepted. To be able to select nodes in a tree, we extend the TA by an additional mechanism for selecting nodes. STA becomes STA=(A, S) where A is a tree automaton, which defines the processed trees and S is a set of selecting states of A. The STA (T) maps the nodes in T to states in S. A node v in T is mapped to state q if and only if there is an accepting run of A on tree T in which a state of vertex v is one of the selecting states in S.

Step 415 represents the inverse mapping of the selected nodes. The result is an index which maps from schema-TA states to relevant data vertices. The online part receives the index, the schema-TA and the twig-TA as inputs.

The online operation in step 210 is described in further detail in steps 425 and 445. It selects schema-TA states that can reach tree nodes which are matched by a twig pattern that defines the twig-TA. This operation is called STA(A) (step 425). In order for the STA(A) to work, we convert the schema-TA to accept sub-trees as described in step 445. The twig-TA accepts sub-trees in the semi-structured data. The schema-TA accepts the complete trees of the semi-structured data. Step 445 ensures both schema-TA and twig-TA are processing same collection of sub-trees. The output of the STA (A) is the selected schema-TA states' mapping to the twig-TA states that recognizes the matched twig-pattern nodes. The merge operation in step 435 receives this mapping and returns vertices that are mapped to the selected schema-TA states in the index. Step 435 is the same as step 215. The output of the indexing is the pruned data.

The index operation performs a holistic selection operation. It selects schema-TA states only if they can express nodes that are matched by the whole twig-pattern. All the other existing indexing techniques such as R. Goldman and J. Widom, “Dataguides: Enabling query formulation and optimization in semistructured databases”, in Twenty-Third International Conference on Very Large Data Bases, pages 436-445, 1997, (hereinafter GW), are not holistic. They cluster nodes according to their labels of nodes in the path from the root. These indexes select the clusters according to labels in the paths of nodes in the twig pattern. The selection according to separate paths is less accurate and thus, less efficient because it extracts more records from the DB files.

### Inverse (Step 415)

The inverse operation in step 415 is described next in more detail. The input to the inverse operation is the selected nodes map from step 405. The input maps the selected nodes records of the semi-structured data to the selecting states of the schema-TA that annotated these nodes. The inverse operation maps the selecting states of the schema-TA to the selected nodes records of the semi-structured data.

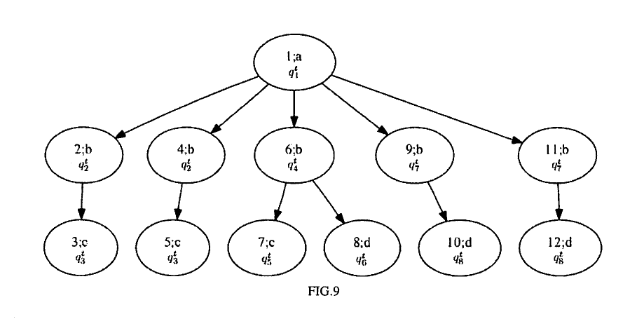

Example: the top-down run in FIG. 9 returns the following selected nodes runₒᵤₜ[1]=q₁^{t}, runₒᵤₜ[2]=q₂^{t}, runₒᵤₜ[3]=q₃^{t}, . . . , runₒᵤₜ[12]=q₈^{t}. The inverse function produces the index: index[q₁^{t}]=1, index[q₂^{t}]=2, 4, index[q₃^{t}]=3, 5, index[q₄^{t}]=6, index[q₅^{t}]=7, index[q₆^{t}]=8, index[q₇^{t}]=9, 11, index[q₈^{t}]=10, 12.

### Sub-Trees TA Construction (Step 445)

The construction of sub-trees TA in step 445 is described next. The Construct sub-trees TA operation receives as an input a UUTA A which recognizes a collection of trees and constructs a new UUTA A^{sub-trees} that recognizes sub-trees of trees recognized by A. In the indexing context, we use this operation to transform the schema-TA, which is given in step 460 and recognizes semi-structured data trees, to schema sub-trees TA in step 450. The twig-TA, which is given in step 470, also recognizes the collection of sub-trees in the semi-structured data. After the transformation is completed, we operated on both collections of sub-trees. The pseudo-code that describes the construction of the sub-trees is given next:

Construct-Sub-tress ( UUTA : (Qᵢₙ, Σᵢₙ, Fᵢₙ, δᵢₙ) )

Output: UUTA : (Qₒᵤₜ,Σₒᵤₜ,Fₒᵤₜ,δₒᵤₜ)
Qₒᵤₜ ← Qᵢₙ;
Σₒᵤₜ ← Σᵢₙ;
Fₒᵤₜ ← Fᵢₙ;
For all subset \tilde{S} ⊂ S where exist δᵢₙ(S,a) = q do:
Add transition δₒᵤₜ(\tilde{S},a) = q;

Example: we get as input the schema-TA from the example and construct sub-tree TA (Q^{s.t.}, Σ^{s.t.}, F^{s.t.}, δ^{s.t.}) where Q^{s.t.}={q₁^{t}, q₂^{t}, q₃^{t}, q₄^{t}, q₅^{t}, q₆^{t}, q₇^{t}, q₈^{t}}, Σ^{s.t.}={a, b, c, d} F^{s.t.}={q₁^{t}} and δ^{s.t.} contains the following transitions: δ^{s.t.}({ },c)=q₃^{t}, δ^{s.t.}({ }),c)=q₅^{t}, δ^{s.t.}({ },d)=q₆^{t}, δ^{s.t.}({ },d)=q₈^{t}, δ^{s.t.}({q₃^{t}},b)=q₂^{t}, δ^{s.t.}({ },b)=q₂^{t}, δ^{s.t.}({q₅^{t},q₆^{t}},b)=q₄^{t}, δ^{s.t.}({q₅^{t}},b)=q₄^{t}, δ^{s.t.}({q₆^{t}},b)=q₄^{t}, δ^{s.t.}({ }),b)=q₄^{t}, δ^{s.t.}({q₈^{t}},b)=q₇^{t}, δ^{s.t.}({ },b)=q₇^{t}, δ^{s.t.}({q₂^{t},q₄^{t},q₇^{t}},a)=q₁^{t}, δ^{s.t.}({q₄^{t},q₇^{t}},a)=q₁^{t}, δ^{s.t.}({q₂^{t},q₇^{t}},a)=q₁^{t}, δ^{s.t.}({q₂^{t},q₄^{t}},a)=q₁^{t}, δ^{s.t.}({q₂^{t}},a)=q₁^{t}, δ^{s.t.}({q₇^{t}},a)=q₁^{t}, δ^{s.t.}({q₄^{t}},a)=q₁^{t}, δ^{s.t.}({ },a)=q₁^{t}.

### STA (A) (Step 425)

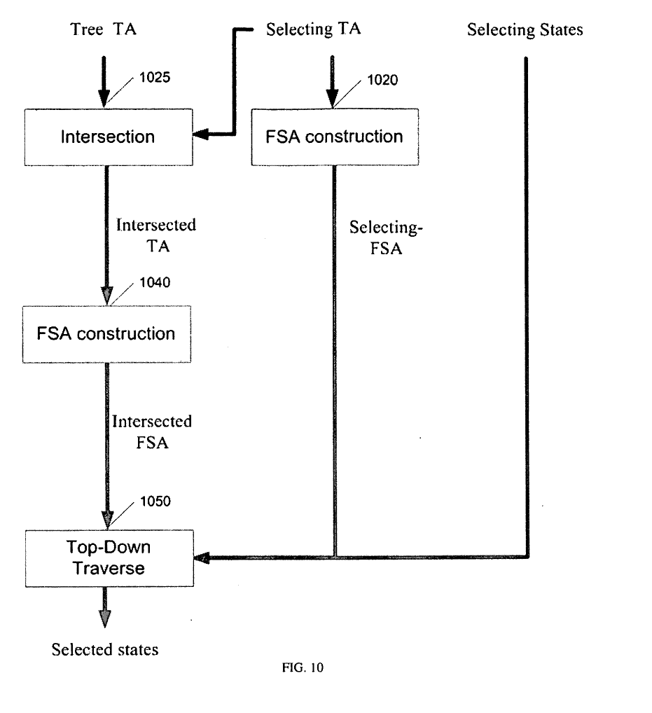

The STA (A) operation extends the STA(T) operation. The STA(T) selects a tree node v in the tree T if there is an accepting run of the selecting TA that maps v to a selecting state. The STA(T) mechanism is extended to operate on a collection of trees that is accepted by a TA. The extended operation STA(A) maps a state q^{tree} of the tree-TA to selecting selecting state q^{selecting} of the selecting-TA if there is a tree T, which is accepted by both automata and a node v that mapped to q^{tree} in a run of the tree-TA and to q^{selecting} in a run of the selecting-TA. FIG. 10 details the STA(A) operation.

### Merge (Step 435)

The merge operation of step 435 is described next in more detail. The inputs to the merge operation are the index from the offline phase and the selected nodes map from the online phase. The index maps schema-TA states to nodes records of the semi-structured data. The selected-states map selected schema-TA states to twig-TA states. The merge operation iterates over the selected schema-TA states which are the keys of the selected-states map. For each selected schema-TA state, it extracts its mapped nodes records in the index and inserts it into a new DB file. The rest of the records are filtered from the file. The pruned nodes records have to be reordered in a traversal order according to the order in the semi-structured DB file.

Merge ( selecting_states, selecting_nodes )
Output: Fileₒᵤₜ filtered data
For each tree state qₜᵣₑₑ which is a selecting_states key:
Add selecting_nodes [qₜᵣₑₑ] to Fileₒᵤₜ

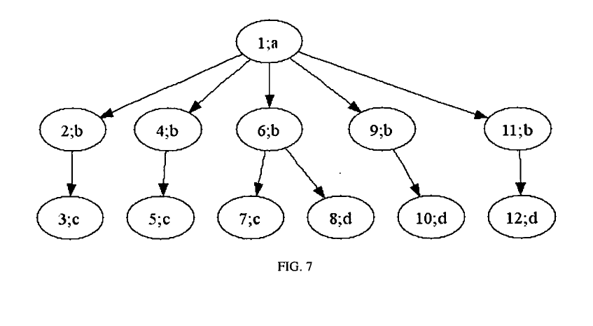

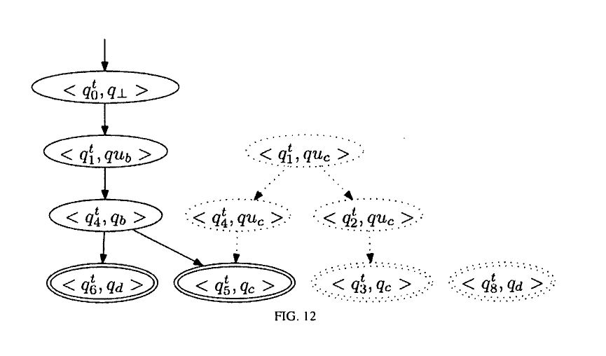

In the description of the inverse processing (step 415), we gave an example from the output of the offline phase. It constructed an index that contains the mappings: index[q₄^{t}]=6, index[q₅^{t}]=7, index[q₆^{t}]=8. The output of the example in FIG. 12 selects the states [symbol] q₄ ^{t},q_{b} [symbol] q₅^{t},q [symbol] , and [symbol] q₆^{t},q [symbol] . Therefore, the mapping is runₒᵤₜ[q₄^{t}]={q_{b}}, runₒᵤₜ[q₅^{t}]={q_{c}}, runₒᵤₜ[q₆^{t}]={q_{d}}. This example selected three schema-TA states: q₄^{t}, q₅^{t} and q₆^{t} (see step 1050 in FIG. 10). As a result, the merge algorithm selects the nodes 6, 7 and 8 and stores them in a pruned DB file as in step 440. This index is more accurate from existing structural indexes (see GW) which are unable to differentiate between nodes that have the same labels on the path from root to nodes. In this semi-structured data (FIG. 7), all nodes with the same label have the same sequence of labels from the root. For example, see nodes 3, 5, 7, where they have the same label c and the same labels “a, b, c” on the path from the root. Therefore, the existing indexes return all the graph nodes which have the twig-pattern labels b, c and d. The holistic indexing enables to generate indexes with better accuracy from those that currently exist.

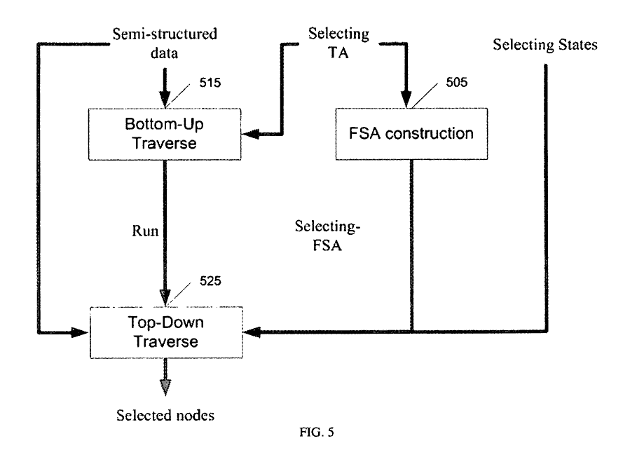

FIG. 5, describes the flow of STA(T), i.e. gives more details of step 405. The STA(T) algorithm operates in two phases: offline and online. The offline part receives the selecting TA and the selecting states. In indexing context, the selecting TA is the schema TA and the selecting states are the schema-TA states. The offline phase constructs a FSA in step 505. The online phase receives as an input the semi-structured data. It has two steps 515 and 525. The bottom-up step 515 traverses through the semi-structured data tree T. It computes the set of states that annotates every node in T. These states are also called reachable states. However, the reachable states do not yet represent the selection, because there may be states that cannot be reached by the root node. The second step 525 traverses T top-down with the FSA constructed in the offline phase, and prunes from the run only the nodes that are mapped to selected states and reached by the root node. The output of the STA (T) operation is the mapping of the selected nodes to the selecting states which annotated them.

### FSA Construction (Step 505)

The FSA construction in step in step 505 is described next. The FSA recognizes the execution of a TA on a collection of all the trees. A TA state qₚ exists in the FSA if there is a tree T and a node vₚ in tree T such that the run of the TA on T maps vₚ into qₚ. There is an edge (qₚ,q_{c}) if there is a tree T and nodes vₚ, v_{c} in tree T such that the run of the TA on T maps vₚ into qₚ and v_{c} into q_{c} and vₚ and v_{c} has a P-C relation. The following pseudo-code describes the FSA construction. In each cycle, the algorithm checks if transitions from the existing children states to a new parent states exist.

```
Construct-FSA ( UUTA : (Qᵢₙ, Σᵢₙ, Fᵢₙ, δᵢₙ) )
Output: FSA : (Qₒᵤₜ,Σₒᵤₜ,q₀_{ₒᵤₜ},Fₒᵤₜ,δₒᵤₜ)
  Qₒᵤₜ^{before} ← empty;
  Qₒᵤₜ^{after} ← empty;
  While Qₒᵤₜ^{before} ⊂ Qₒᵤₜ^{after} do:
    Qₒᵤₜ^{before} ← Qₒᵤₜ^{after};
    For all subset S ⊂ Qₒᵤₜ^{after} and state q ⊂ Qᵢₙ do:
      If exists δᵢₙ(S,a) = q then:
          If S = { } then:
            Add q to Fₒᵤₜ;
          Add q to Qₒᵤₜ^{after};
        For all qₛ ε S do:
            Add transitions δₒᵤₜ(q,qₛ) = qₛ
  Qₒᵤₜ ← Qₒᵤₜ^{after};
  Σₒᵤₜ ← Σᵢₙ;
  q₀_{ₒᵤₜ} ← Qₒᵤₜ^{after} ∩ Fᵢₙ
```

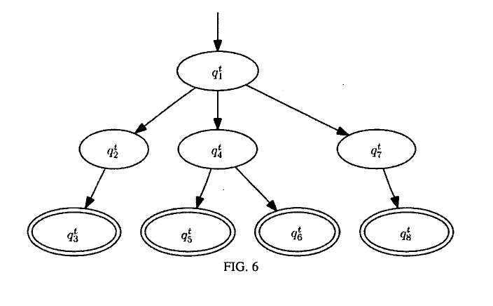

Example how the Construct-FSA constructs FSA from the UUTA: we get as input the schema-TA (Q^{t}, Σ^{t}, F^{t}, δ^{t}) where Q^{t}={q₁^{t}, q₂^{t}, q₃^{t}, q₄^{t}, q₅^{t}, q₆^{t}, q₇^{t}, q₈^{t}}, Σ^{t}={a, b, c, d} F^{t}={q₁^{t}} and δ^{t} contains the following transitions: δ^{t}({ },c)=q₃^{t}, δ^{t}({ },c)=q₅^{t}, δ^{t}({ },d)=q₆^{t}, δ^{t}({ },d)=q₈^{t}, δ^{t}({q₃^{t}},b)=q₂^{t}, δ^{t}({q₅^{t},q₆^{t}},b)=q₄^{t}, δ^{t}({q₈^{t}},b)=q₇^{t}, δ^{t}({q₂^{t},q₄^{t},q₇^{t}},a)=q₁^{t}. The example in FIG. 6 illustrates the FSA that is constructed from this example schema-TA.

### Bottom-Up Traverse (Step 515)

The bottom-up traverse in step 515 is described next. The input to the bottom-up traverse is the semi-structured data tree and the selecting-TA. The semi-structured data is stored in a structured DB. We do not need to reconstruct the tree in order to traverse it. Instead, we use a stack (see CLRS) to store the node records during the tree traversal. The ID of the nodes records in the data file may be ordered in any top-down or bottom-up traversal using for example a DFS (see CLRS) traversal. The traversal in the algorithm is bottom up. If the traversal order in the algorithm is top down, like in this example, we read the records in the file in reverse—from the end to the start. A reverse-DFS orders the nodes in a bottom-up order. The algorithm is described in the following pseudo-code:

```
Bottom up traverse (Fileᵢₙ , Selecting UUTA : (Qᵢₙ, Σᵢₙ, Fᵢₙ, δᵢₙ) )
Output: run that maps nodes in Fileᵢₙ to states in Qᵢₙ
Stack ← empty;
While exists r in Fileᵢₙ do:
  Let r_{c} be the top of Stack;
  if r is a leaf
    For all transitions δᵢₙ({ },a) = q where a is the label of node record
    r do:
      Add q to run[r];
  Else if r and r_{c} have P-C relation then:
    Pop all children records r_{c}¹,...,r_{c}ⁿ from Stack that have P-C relation
    with r.
    For all transitions δᵢₙ({s₁,...,sₙ},a) = q where sᵢ ε run[r_{c}ⁱ] for
    1 ≦ i ≦ n do:
      Add q to run[r]
  Push r to Stack ;
```

FIG. 6 illustrates the FSA that was constructed from the example of FSA construction in step 505. A state is denoted by a circle. The label in the circle denotes the state. A transition is denoted by an arrow. The symbol of the transition is the label of the incoming state. The final states are denoted by a double circle. The start state is denoted by an extra incoming arrow.

In order to give a bottom-up traversal example, we first give an example for a semi-structured tree data stored in DB files. An example for semi-structured data is given in FIG. 7. The tree data form is stored in the structured DB as file of records. In examples described below, we denote a file that stores label ‘a’ nodes by Fileₐ. We order the records in a Depth First Search (DFS). A description of DFS is given in Corman, Leiseson, Rivest and Stein, “Introduction to algorithms”, MIT Electrical Engineering and Computer Science Series, 1990, (referred to hereinafter as “CLRS”).

Each node is denoted by a circle. The label of the circle of node v is in the format ‘v; label (v)’. The edges are denoted by arrows. The node IDs in the figures are the DFS (see CLRS) traversal order of the tree nodes. The DB file in this example contains the following records: (1,a), (2,b) (3,c), (4,b), (5,c), (6,b), (7,c), (8,d), (9,b), (10,d), (11,b), (12,d). The DB can also split the nodes into files according to their labels. In this example Fileₐ contains node 1. File_{b} contains nodes 2, 4, 6, 9, 11. File_{c}, contains nodes 3, 5, 7. File_{d} contains nodes 8, 10, 12.

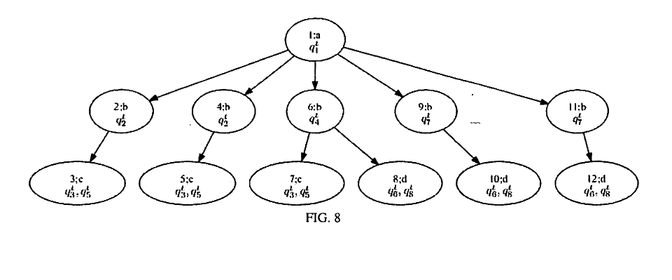

FIG. 8 is an example of a bottom run of the schema-TA on the semi-structured data in FIG. 7. A tree node v in FIG. 8 is denoted by a circle. It has a two lines label. The first line is in the format ‘v; label (v)’. The second line is in the format q₁, . . . , qₙ. These states are mapped to the node i.e. run[v]=q₁, . . . , qₙ;

The following table describes part of the bottom-up run. The nodes are extracted in reverse order. Each row in the table defines iteration. In each row, the table stores the node r that is extracted in this iteration, the node-records Stack at the end of the iteration and states that were add run[r].

| Node | Stack | Run |
|---|---|---|
| 12 | | run[12] = {q₆^{t}, q₈^{t}} |
| 11 | 12 | run[11] = {q₇^{t}} |
| 10 | 11 | run[10] = {q₆^{t}, q₈^{t}} |
| 9 | 11, 10 | run[9] = {q₇^{t}} |
| 8 | 11, 9 | run[8] = {q₆^{t}, q₈^{t}} |
| 7 | 11, 9, 8 | run[7] = {q₃^{t}, q₅^{t}} |
| 6 | 11, 9, 8, 7 | run[6] = {q₄^{t}} |

### Top-Down Traverse (Step 525)

The inputs to the top-down traverse are the run of step 515, the semi-structured data, the selecting FSA, which was constructed in the offline phase, and the set of selecting states. In the indexing context, the selecting TA is the schema TA. We need to map every node to a state and therefore we select all states and Sᵢₙ=Qᵢₙ. In order for the index to become minimal, we use a STA that selects a single state for each node in the tree. Below is the pseudo-code that describes the top-down traverse:

```
Top-down traverse ( runᵢₙ, Fileᵢₙ, FSA : (Qᵢₙ, Σᵢₙ,q₀_{ᵢₙ},δᵢₙ), Selecting
States : Sᵢₙ)
Output: runₒᵤₜ mapping of nodes records in Fileᵢₙ to selected states in Sᵢₙ
  runₒᵤₜ ← empty;
  If q₀_{ᵢₙ} is not in runᵢₙ[root] then
    Return runₒᵤₜ;
  Stack ← root;
  Add q₀_{ᵢₙ} to runᵢₙ[root];
  While exists r in Fileᵢₙ do:
      Let rₚ be the top of Stack;
      While rₚ and r do not have P-C relation then:
        Pop record from Stack;
      For all states q_{c} in runᵢₙ[r] do:
        If exists δᵢₙ(qₚ,q_{c}) = q_{c} where qₚ in runᵢₙ[rₚ] then:
          If q_{c} is in Sᵢₙ then:
              Add q_{c} to runₒᵤₜ[r];
        Else
          Remove q_{c} from runᵢₙ[r];
      Push r to Stack ;
```

### Example of Top-Down Traversal Operation

FIG. 9 is the output of a top-down traverse on the run of the bottom-up phase in FIG. 8 and the FSA in FIG. 7. A tree node v in FIG. 8 is denoted by a circle. It has a two lines label. The first line is in the format ‘v; label (v)’. The second line is in the format q denotes the selecting states of node v (runₒᵤₜ[v]). The following table describes a portion of the top-down run. The nodes are extracted in reverse order. Each row in the table below defines iteration. The table stores in each row the node r that is extracted in this iteration, the node-records Stack at the end of the iteration and the states that were add runₒᵤₜ[r]. The runₒᵤₜ maps each vertex to a single node and, therefore, it is can be used to construct an index.

| r | Stack | runₒᵤₜ[r] |
|---|---|---|
| 1 | 1 | runₒᵤₜ[1] = {q₁^{t}} |
| 2 | 1, 2 | runₒᵤₜ[2] = {q₂^{t}} |
| 3 | 1, 2, 3 | runₒᵤₜ[3] = {q₃^{t}} |
| 4 | 1, 4 | runₒᵤₜ[4] = {q₂^{t}} |

### STA(A) (Step 425)

FIG. 10 describes the flow of the STA (A) algorithm in step 425 in detail. The input to the algorithm is a tree TA (step 1015). In the indexing context the tree TA is the schema sub-trees TA. Other inputs are the selecting TA and the selecting states. In the indexing context, the selecting TA is the twig TA. The selecting states are the twig TA states that express the twig nodes.

The STA(A) algorithm resembles the STA(T) algorithm in step 405 with some differences. The offline phase is the same as the offline phase in the STA(T) algorithm. The offline phase in step 1020 constructs a selecting FSA from the selecting TA. It is done in the same way as done by STA(T) in step 505. The online phase in steps 1025-1050 is different. Instead of traversing a tree, the algorithm intersects in step 1025 the selecting TA and the tree TA. The output from this intersection is called an intersected TA. The STA(A) algorithm constructs in step 1040 the intersected FSA from the intersected TA. The construction process is the same as the selecting FSA construction in steps 1020 and 505. The top-down traversal (step 1050) uses the selecting FSA to traverse the intersected FSA states. Each FSA state contains two components: selecting TA state and tree TA state. The top-down traversal selects states of the intersected FSA that contain a selecting state. The output is a mapping of tree-TA states to selecting TA states.

### Intersection (Step 1025):

The intersection between two UUTA A₁=(Q₁, Σ, F₁, δ₁) and A₂=(Q₂, Σ, F₂, δ₂) is the automaton A₁∩A₂=(Q₁×Q₂, Σ, F₁×F₂, δ_{1×2}) where δ_{1×2}( [symbol] S₁,S₂ [symbol] ,a)= [symbol] q₁,q₂ [symbol] only if δ_{1×2}(S₁,a)=q₁, and δ_{1×2}(S₂,a)=q₂.

### Selecting FSA (Step 1030):

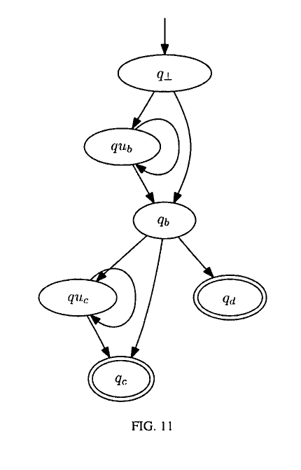

Exemplarily, the Selecting FSA is constructed from the twig-TA of the pattern in FIG. 3. This FSA recognizes all the words in Q* that are composed from twig-TA states. The strings, which are accepted by the FSA, are mapped by the twig-TA runs to nodes from root to leaves. This FSA is illustrated in FIG. 11. A state is denoted by a circle. The label in the circle denotes the state id. A transition is denoted by an arrow. The symbol of the transition is the label of the incoming state. A final state is denoted by a double circle. The start state is denoted by an extra incoming arrow.

### Intersected FSA Construction (Step 1040)

The intersected FSA is constructed from the intersection between the selecting TA input, which is the twig TA, and the tree TA input, which is the schema sub-trees TA. FSA has a single start state. We add to the tree-TA a final state, which replaces the original final state. The new final state has a transition from each original-TA accepting state with label ⊥. The intersected FSA is illustrated in FIG. 12. In FIG. 12 a state is denoted by a circle. The label in the circle denotes the state id. A transition is denoted by an arrow. The symbol of the transition is the label of the incoming state. A final state is denoted by a double circle. The start state is denoted by an extra incoming arrow.

Dead states are states that cannot be reached from the start state. We denote the dead states by dotted lines. The top-down traverse in step 1050 does not select these states because they are not reachable.

### Top-Down Traverse (Step 1050)

The top-down traverse process of step 1050 is described next. The inputs to the top-down traverse are the intersected FSA and the selecting FSA which is constructed in the offline phase. A selecting twig state q^{v} is a twig state that was constructed from twig-pattern nodes v. The q^{v} state identifies the nodes that match the twig-pattern of node v. The top-down traverse uses a recursive function to traverse the intersected FSA. The parameter [symbol] qₜᵣₑₑ^{p},q_{selecting}^{p} [symbol] is the current node which is traversed in the intersected FSA. The function is called with the root node [symbol] q₀_{ₜᵣₑₑ},q₀_{_{selecting}} [symbol] . The following pseudo code describes his algorithm:

```
Top-down traverse ( Selecting FSA : (Q_{selecting},
Σ_{selecting},q₀_{_{selecting}},F_{selecting},δ_{selecting}),
        Selecting States : S_{selecting},
        Intersected FSA : (Qₜᵣₑₑ × Q_{selecting},
        Σ, [symbol] q₀_{ₜᵣₑₑ},q₀_{_{selecting}} [symbol] ,F_{tree×selecting},δ_{tree×selecting}), [symbol]
        qₜᵣₑₑ^{p},q_{selecting}^{p} [symbol] ε (Qₜᵣₑₑ× Q_{selecting})
Output: runₒᵤₜ mapping of tree TA states to selecting states in S_{selecting}
For each tree state [symbol] qₜᵣₑₑ^{c},q_{selecting}^{c} [symbol] that has a transition
from [symbol] qₜᵣₑₑ^{p},q_{selecting}^{p} [symbol] in the intersected
FSA do:
  If q_{selecting}^{c} is in S_{selecting} then:
      Add q_{selecting}^{c} to runₒᵤₜ[qₜᵣₑₑ^{c}];
  Top down traverse ( Selecting FSA, Selecting States, Intersected FSA, [symbol]
        qₜᵣₑₑ^{c} ,q_{selecting}^{c} [symbol] );
```

In the example (FIG. 12) the algorithm selects the states [symbol] q₄^{t},q_{b} [symbol] q₅^{t},q_{c} [symbol] , and [symbol] q₆^{t},q_{d} [symbol] . Therefore, the mapping is runₒᵤₜ[q₄^{t}]={q_{b}}, runₒᵤₜ[q₅^{t}]={q_{c}}, runₒᵤₜ[q₆^{t}]={q_{d}}.

### Join (Step 115 and 120)

The join operation in step 115 and 120, which is also described in steps 225-245, is now described in more detail. In the join operation, we utilize the same STA(A) mechanism used for the indexing operation. The algorithm iteratively models parts of the data as a tree-TA. It also models the twig pattern as a twig-TA and then it uses the STA (A) mechanism to select node records that partially match the twig-pattern. Algorithms that process a twig-pattern in holistic way are known, for example N. Bruno, N. Koudas, and D. Srivastava, “Holistic twig joins: optimal XML pattern matching”, Proceedings of SIGMOD, pages 310-321, 2002. However, they do the processing heuristically and therefore they do not process the exact twig pattern. The semi-structured DB files are inputs to the join operation. Each label has a different DB file. A file of records with label a is denoted by fileₐ. When a twig-pattern is processed the join mechanism is used to join the node records from multiple fileₐ where a εΣ_{twig}.

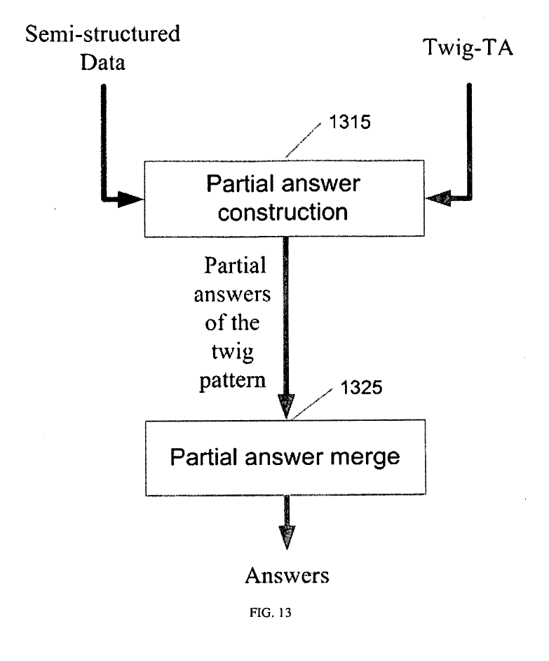

FIG. 13 describes the join operation flow. The semi-structured data is the input to the join operation. The semi-structured data is either DB files or indexing output pruned DB files. Another input to the join operation is the twig-TA. The algorithm's outputs are “answers”, i.e. tuples of node records that match the twig pattern. The answers are constructed in two steps: 1. Construction of an ordered list of partial twig answers (step 1315). The partial answers are paths of node records. The paths match a path-pattern that exists in the twig tree-pattern. Step 1315 is the same as steps 225-240; 2. Merge of the sorted lists of node-paths and construction of trees which compose the answer (step 1325). Step 1325 is the same as step 245.

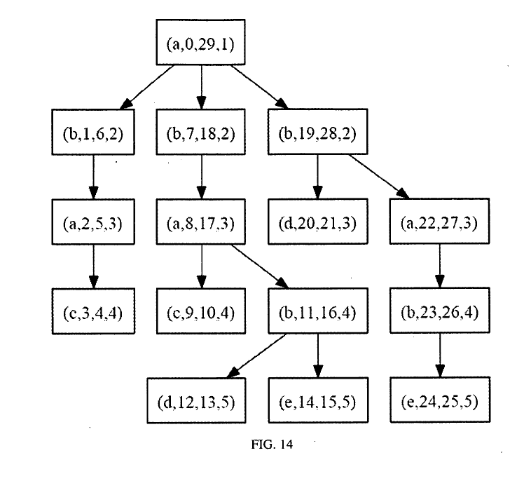

FIG. 14 is an example for semi-structured data that is an input to the join operation. In this example, we use node records with region encoding. Next, region encoding is explained. Region code of node v is denoted by (startᵥ, endᵥ, levelᵥ) where startᵥ is the position in the tree from which a DFS (see CLRS) based traverse starts, endᵥ, is the position in the tree from which the DFS based traverse ends and levelᵥ, is the node level in the tree. Region encoding supports efficient evaluation of structural relationships. In FIG. 14, a DFS based traverse begins in the root (a, 0, 29, 1). It means that we start with the root node ‘a’ at position 0 level 1 and ends in the root itself after visiting 30 nodes. Each node in the traverse is visited twice. Let rᵢ=(startᵢ, endᵢ, levelᵢ) and rⱼ=(startⱼ, endⱼ, levelⱼ) be two nodes records in the tree. rᵢ and rⱼ have A-D relationship if and only if startᵢ<startⱼ<endᵢ. To have a P-C relationship, rᵢ and rⱼ must have A-D relationship and levelᵢ=levelⱼ−1.

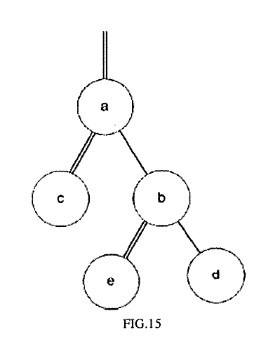

FIG. 15 describes the twig-pattern input for the join operation. The UUTA, which is constructed from the twig pattern in FIG. 15, is (Q_{twig}, Σ_{twig}, F_{twig}, δ_{twig}) where Q_{twig}={q_{⊥}, qₐ, quₐ, q_{b}, q_{c}, qu_{c}, q_{d}, qₑ, qu_{c}}, Σ_{twig}={⊥, a, b, c, d, e} and F_{twig}={q^{⊥}}. The flowing transitions are constructed from the twig pattern nodes: δ_{twig}({ },e)=qₑ, δ_{twig}({ }, d)=q_{d}, δ_{twig}({ },c) q_{c}, δ_{twig}({q_{d},qₑ},b)=q_{b}, δ_{twig}({quₑ,q_{d}},b)=q_{b}, δ_{twig}({q_{c}, q_{c}},a)=qₐ, δ_{twig}({qu_{c},q_{b}},a)=qₐ, δ_{twig}({qₐ},⊥)=q_{⊥}, δ_{twig}({quₐ},⊥)=q^{⊥}. For each αεΣ_{twig}, the flowing transitions are constructed from the twig pattern edges: δ_{twig}({q_{c}},α)=qu_{c}, δ_{twig}({qu_{c}},α)=qu_{c}, δ_{twig}({qₑ},α)=quₑ, δ_{twig}({quₑ}, α)=quₑ, δ_{twig}({qₐ},α)=quₐ, δ_{twig}({quₐ},α)=quₐ.

### Partial Answers Construction (Step 1315)

The actions in step 1315 are described next. The algorithm iteratively traverses the semi-structure data. In each iteration, the algorithm extracts (step 1615) a finite number of nodes from the DB files. Step 1615 is the same as step 225. Step 1620 checks whether node records were extracted from the DB files. If new nodes were extracted, then the algorithm constructs a prediction automaton from the extracted nodes. This construction, which is given in step 230, is detailed in steps 1630-1640. In step 1630, a prediction-tree (T^{Prediction}) is formed from the current extracted nodes of step 1620. The prediction-tree predicts the tree structure of the entire data. The prediction-tree structure reflects the structure for the current extracted nodes and for the nodes which have not yet been extracted from the DB files. These nodes are called future-nodes. We denote by future position the minimal start position for fileₐ for all a εΣ^{twig} of nodes records which have not yet extracted by the algorithm. The future position advances.

The prediction-tree receives its name because it predicts the future-nodes structure from the currently extracted nodes. The prediction-tree has two vertices types: real-vertices (V^{Real}) and virtual-vertices (V^{virtual}). A real-vertex is mapped into a single extracted node record. A virtual-vertex indicates the existence of a gap in our understanding of the structure of the data. A virtual data defines labels and positions of multiple future-nodes which may appear in the semi-structured data between the real-vertex parent of the virtual-vertex and its real-vertices children. The prediction-tree combines two sub-trees: T^{Current} and T^{Future}. The T^{Current} is composed entirely from real-vertices. T^{Future} contains a mixture of real and virtual vertices. The T^{Future} nodes are identified by future position IDs. From the prediction-tree, the algorithm constructs tree automata in step 1640.

Next, more details of step 235 are given in steps 1650 and 1660. In step 1650, the algorithm constructs from the prediction automaton a sub-tree automaton. The sub-trees automaton construction is given in step 1650. This construction is the same as the construction in step 445. Step 1660 performs the STA(A) operation described in step 425. The input to the STA(A) is the twig-TA. The STA(A) result is the selected states in the prediction TA, which also constitute the selected nodes in the prediction-tree. The selected-nodes are input to the next iteration for the node-extraction process in step 1615. If the node extraction process does not extract nodes from the DB files, then the algorithm outputs partial twig-pattern answers that exist in T^{Current}. The output process is done in step 1670, which is the same as step 240.

### Prediction Tree Construction (Step 1630)

This section describes the prediction tree construction in step 1630. This construction includes two tasks:

1) Construction of real-vertices for the prediction-tree. A real-vertex is identified by the start position of its node. It is located in the prediction-tree in the same place as its location between its minimal ancestor vertex and its minimal descendants in the original semi-structured data. The records^{Prediction} function maps each real vertex to the extracted node.
2) Construction of virtual-vertices for the prediction-tree. A virtual-vertex v fills the gap between the real-vertex of its parent p and the real-vertices of its children where each child is denoted by c in the prediction tree. The positions^{Prediction} function maps v to startᵤ where u is a future node. A node u appears between p and c. Therefore, u is a descendant of the records^{Prediction}[p] but not a descendant of records^{Prediction}[c]. Therefore, startᵤ is located between startₚ and endₚ but not in between start_{c} and end_{c}. startᵤ is also bigger or equal to future position in order to be a future-node. v is assigned to be the minimal startᵤ. The label function maps v to labelᵤ in node u which appears between p and c in the data. labelᵤ can be a if u can be in fileₐ. We check the next future record rₐ, in fileₐ. If startᵣ_{ₐ} . . . ∞ and positions^{Prediction}[v] have common positions then u can be in fileₐ and αεlabels^{Prediction}[v].
The pseudo code of the prediction tree construction algorithm is given below:

```
Construct Prediction Tree (extracted nodes records, semi-structured data )
Output: T^{Prediction} = (V^{Prediction}, E^{Prediction}, label^{Prediction}, records^{Prediction},
positions^{Prediction})
    Where:
    V^{Prediction} = V^{Virtual} ∪ V^{Real},
    The label^{Prediction} is a mapping from nodes to labels.
    The records^{Prediction} maps real-vertices to its extracted record.
    The positions^{Prediction} maps each node to its possible node records start
    and end encodings.
Add v^{root} to V^{Real} in T^{Prediction};
Map records^{Prediction}[v^{root}] to record r^{root} with label ⊥ and encoding
(−∞,+∞,0).
For each nodes record r in input do:
  Construct Real Vertices (T^{Prediction},r,v^{root} );
For each v^{r} ε V^{Real} do:
  Construct Virtual Vertices (T^{Prediction},r,v^{root},data);
```

The above pseudo code uses Construct Real Vertices as an internal function that constructs real vertices. Its code is described below:

```
Construct Real Vertices (T^{Prediction}, nodes record r, v^{p} ε V^{Prediction} )
If exists child v^{c} of v^{p} where records^{Prediction}[v^{c}] and r have a A-D relation
do:
  Construct Real Vertices (r, v^{c});
Else
  Add node V^{r} to V^{Real};
  Set records^{Prediction}[v^{r}] to r;
  Add edge (v^{p},v^{r});
  For each child v^{c} of v^{p} where r and records^{Prediction}[v^{c}] have a A-D
  relation do:
    Replace edge (v^{p},v^{c}) with edge (v^{r},v^{c});
```

The construct prediction tree algorithm, described above, also uses an internal function that constructs virtual vertices whose code is given below:

```
Construct Virtual Vertices (T^{Prediction},v^{r} ε V^{Real},semi-structured data)
  Let positions^{v} ← startᵥ,...,endᵥ as in records^{Prediction}[v^{r}];
  Remove from positions^{v} 1,...,future−1;
  For each child v^{c} of v^{r} do:
    Remove from positions^{v} startᵥ^{c},...,endᵥ^{c} as in records^{Prediction}[v^{c}];
  If positions^{v} is not empty then:
    Add node v^{v} to V^{vritual};
    Set positions^{Prediction}[v^{v}] to positions^{v};
    Add edge (v^{r},v^{v});
    For each child v^{c} of v^{r} where records^{Prediction}[v^{r}] and
    records^{Prediction}[v^{c}] do not have
    a P-C relation do:
      Replace edge (v^{r},v^{c}) with edge (v^{v},v^{c});
      For each label in a ε Σ^{twig} do:
        If startᵣ_{^{a}}...∞∩ positions^{Prediction}[v^{v}] is not empty for next
        r^{a} ε file^{a} then:
          Add a to label^{Prediction}[v^{v}];
```

### Example for a Prediction Tree Construction

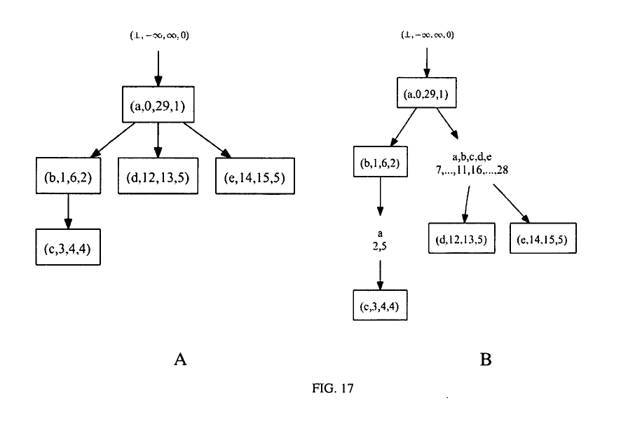

FIG. 17 describes the prediction-tree construction from the data in FIG. 14. Real-vertex for node v is denoted by a white box. It is in the format (label (v), startᵥ, endᵥ, levelᵥ). The dummy root record is does not have a box. Virtual-vertex v is denoted by a grey box. It is in the format ‘label (v); positions (v)’ where label (v)=label, . . . , label are the labels of v and positions (v)=start, . . . , start are the positions of the future-nodes of v;

The prediction-tree is initialized to be the empty tree. FIG. 17(a) describes the prediction-tree after the algorithm in table 10 added the real-vertices of the records at the beginning of the files: rₐ=(0, 29, 1), r_{b}=(1, 6, 2), r_{c}=(3, 4, 4), r_{d}=(12, 13, 5) and rₑ=(14, 15, 5). FIG. 17(b) describes the prediction-tree after the above algorithm added the virtual vertices. There are two virtual vertices. 1. Virtual vertex defines future-nodes which are descendants of the extracted record r_{b} and therefore are in the range 1 to 6. However, these future nodes are not descendants of the extracted node r_{c}, and therefore are not in the range 3 to 4. To summarize, this virtual-vertex defines future records in positions 2 and 5. ‘a’ is a label of this virtual-vertex because after the extraction the next record in fileₐ is r′ₐ=(2, 5, 3). So the range 2 . . . ∞ includes positions 2 and 5. The start position of the records in the rest of the files: b, c, d and e are 7, 9, 20 and 24, respectively. Therefore, future-nodes in positions 2 and 5 do not have the labels ‘b’, ‘c’, ‘d’ and ‘e’. The future position in this example is 2 because r′ₐ=(2, 5, 3) has the minimal start position.

### Prediction TA Construction (Step 1640):

The prediction of TA construction (step 1640) is described next. This algorithm constructs A^{Tree} from T^{Prediction}. The states of A^{Tree} are the T^{Prediction} vertices. Two construction rules construct the prediction-tree into an A^{Tree}:

1) Real vertex rule: constructs transitions which annotate real-vertices. A real-vertex is annotated when all its children exist;
2) Virtual vertex rule: constructs transitions which annotate virtual-vertices. A virtual-vertex is annotated when a subset of its children exists.
The constructed A^{Tree} accepts (in TA sense) the collection of all the predicted trees. The following pseudo code describes the prediction TA construction algorithm:

```
Construct Prediction TA (T^{Prediction} =(V^{Prediction}, E^{Prediction}, label^{Prediction}))
Output: UUTA : (Qₒᵤₜ,Σₒᵤₜ ,Fₒᵤₜ,δₒᵤₜ)
  Qₒᵤₜ ← V^{Prediction};
  Σₒᵤₜ ← Σ^{Twig};
  Fₒᵤₜ ← {v^{root}};
  For all v ε V^{Real} do:
    Add transition δₒᵤₜ(S,label^{Prediction}(v) ) = v where S is composed from
    v children;
  For all v ε V^{Virtual} do:
    For all label a in a ε label^{Prediction}(v) do:
      For all subset S which is composed from v children's or v itself do:
        Add transition δₒᵤₜ(S,a ) = v
```

### Example for the Construction of Prediction TA

The algorithm constructs the (Qₒᵤₜ, Σₒᵤₜ, Fₒᵤₜ, δₒᵤₜ) UUTA from the prediction-tree in FIG. 17b where Qₒᵤₜ={−∞, 0, 1, 2, 3, 7, 12, 14}, Fₒᵤₜ={−∞}, Σₒᵤₜ={a, b, c, d, e, ⊥}. The real vertex rule construct the following transitions: δₒᵤₜ({ },c)=3, δₒᵤₜ({ },d)=12, δₒᵤₜ({ },e)=14, δₒᵤₜ({2},b)=1, δₒᵤₜ({1, 7},a)=0, δₒᵤₜ({0},⊥)=−∞.

The virtual vertex rule constructs the following transitions: δₒᵤₜ({ },a)=2, δₒᵤₜ({2},a)=2, δₒᵤₜ({3},a)=2, δₒᵤₜ({2, 3},a)=2, δₒᵤₜ({ },α)=7, δₒᵤₜ({12},α)=7, δₒᵤₜ({14},α)=7, δₒᵤₜ({7},α)=7, δₒᵤₜ({12, 14},α)=7, δₒᵤₜ({14, 7},α)=7, δₒᵤₜ({12, 7},α)=7, δₒᵤₜ({12, 14, 7},α)=7.

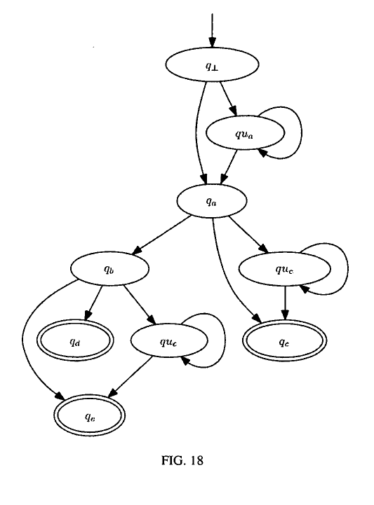

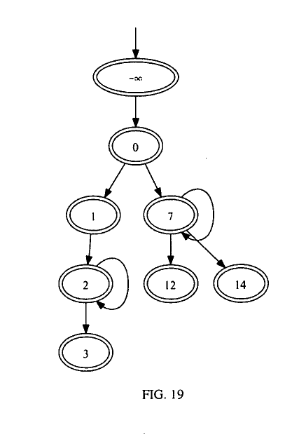

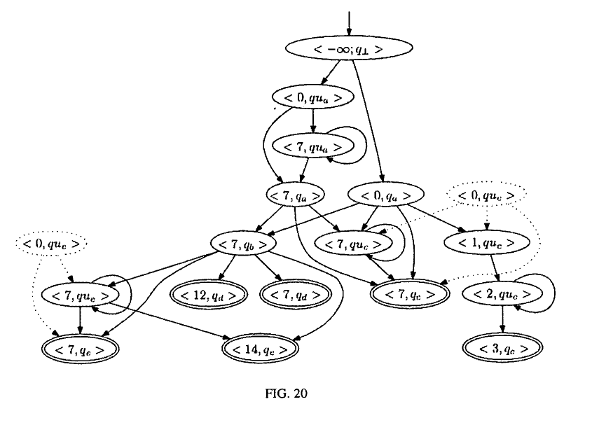

After the construction of the prediction TA, we give examples to steps 1650 and 1660. The prediction TA is converted to accept in the sub-trees in step 1650. Then, the STA(A) operation in step 1660 selects the prediction TA states that match selecting twig TA states. This operation returns the mapping of the selected prediction TA states to the selecting twig TA states. FIG. 18 describes the twig FSA for the TA. The TA is constructed from twig pattern in FIG. 15. FIG. 19 describes the prediction FSA which is constructed from the prediction tree that is shown in FIG. 17b. The FSA of the intersection between the prediction TA and the tree TA is given in FIG. 20. Then, the twig selecting states are the states which were constructed from its nodes: S={qₐ, q_{b}, q_{c}, q_{d}, qₑ}. The selected T^{Prediction} vertices are: selected_states(0)={qₐ}, selected_states(3)={q_{c}}, selected_states(3)={q_{c}}, selected_states(7)={qₐ, q_{b}, q_{c}, q_{d}, qₑ}, selected_states(12)={q_{d}} and selected_states(14)={qₑ}. We see that tree TA states 1 and 2 are not selected. Therefore, record r_{b}=(1, 6, 2) will be ignored in the next iteration.

### Nodes Extraction (Step 1615)

This section describes the nodes extraction in step 1615. To limit memory usage, the algorithm uses a fixed number of nodes records K from each DB file to construct the prediction tree. The algorithm first takes the selected nodes records from the previous iteration. If the vertices in the T^{Current} were outputted in the previous iteration then they are not taken in the current iteration. The following pseudo code describes the node extraction:

```
Extract Nodes ( selected nodes, T^{Prediction},output)
Output: extracted nodes
  For each tree label a ε Σ^{twig} do:
    Let recordsₐ an empty set;
    For each node v in selected nodes where label(v) = a do:
      If output is empty
        Add records^{Prediction}[v] to recordsₐ;
      Else If records^{Prediction}[v] was not output or
          is an is an ancestor of such vertex then:
        Add records^{Prediction}[v] to recordsₐ;
    While recordsₐ size < K do:
      Extract next record rₐ from fileₐ;
      If exists a selected node v ε V^{Virtual} where in startᵣ_{ₐ} ε
      positions^{Prediciton}
        add rₐ to recordsₐ;
  Add recordsₐ to extracted nodes;
```

### Partial Answers Output (Step 1670)

The output of the partial answers in step 1670 is described next. When all the real vertices in the prediction tree are selected, then the record paths, which are mapped into nodes in T^{Current}, are added to the output. The output maps from the selecting twig states, which identify nodes in the twig pattern, to paths of node records which expected to be part of the twig answers. The output portion of the algorithm traverses T^{Current} top-down like step 525. This output processing uses the twig FSA and the selected-states (step 1665) from the previous iteration as inputs to the top-down traversal. The following pseudo code describes this recursive algorithm. The algorithm's inputs are: a parent vertex in T^{Current} and a twig-TA state that selects it. It operates on the parent-vertex children. If a child is not selected then the recursion is passed to it with the same state. Otherwise, the algorithm finds transitions to the selected child states and passes the recursion to the found child and state. If a selecting state of a child indicates a new tree pattern than the path is cleared.

```
Output Path (T^{Current},selected nodes,
          FSA :^{(Q}ᵢₙ, Σᵢₙ,q₀_{ᵢₙ},Fᵢₙ,δᵢₙ), vᵢₙ ε V^{Prediction}, qᵢₙ,pathᵢₙ₎
Output: set of record-paths^{paths}ₒᵤₜ
  For each child v_{c} of vᵢₙ do:
    If selected_states(v_{c}) is empty then:
      Output Path (T^{Current},selected nodes, FSA, v_{c} , qᵢₙ, pathᵢₙ)
    Else
      For all qᵥ_{_{c}} ε selected_states(v_{c}) do:
        If δᵢₙ (qᵢₙ,qᵥ_{_{c}}) exists then
            Add records^{Prediction}[v_{c}] to pathᵢₙ;
            If records^{Prediction}[v_{c}] was not already output then:
              Add pathᵢₙ to pathsₒᵤₜ[qᵥ_{_{c}}];
            Output Path (T^{Current},selected nodes, FSA, v_{c} , qᵥ_{_{c}}, pathᵢₙ);
        Else if qᵥ_{_{c}} mark the twig root
            Clear pathᵢₙ and add records^{Prediction}[v_{c}] to pathᵢₙ;
            Output Path (T^{current},selected nodes, FSA, v_{c} , qᵥ_{_{c}},);
            If records^{Prediction}[v_{c}] was not already output then:
              Add pathᵢₙ to pathsₒᵤₜ[qᵥ_{_{c}}];
    Mark records^{Prediction}[v_{c}] as outputted;
```

### Example for a Join Operation

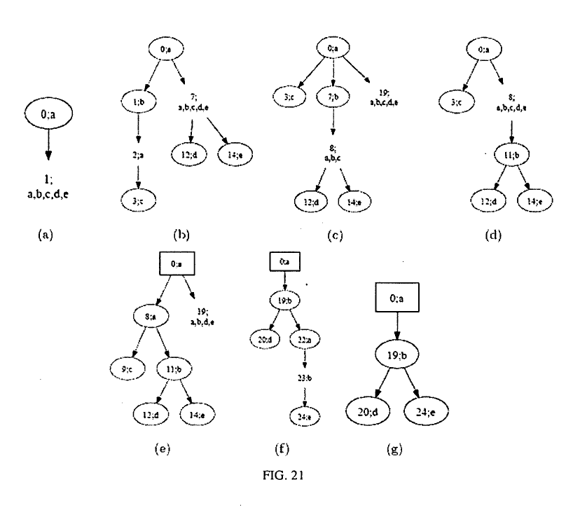

FIG. 21 illustrates the run of the join algorithm. It gets two inputs: 1) the semi-structured data in FIG. 14 and 2) the twig-pattern in FIG. 15. FIGS. 21(a)-21(g) describe the T^{Prediction} structure in iterations a-g, respectively. A white circle in FIG. 21 denotes a real-vertex. A gray circle denotes a virtual-vertex. A box denotes a past vertex which has not yet been removed because it is an ancestor of the current real-vertex. The labels inside the vertices have the syntax ‘Id; label, label2, . . . , labeln’.

Iterations (d), (e) and (g) add paths to the partial answer. In these iterations, all the real-vertices are selected by the STA (A) operations. Therefore, T^{Current} is an output.

The partial output answers are given in the table below. There are three twig answers: Two of the answers are rooted in node 0. The other is rooted in node 8. We see in the table that the paths are not ordered according to the traversal order. For example, q_{b} starts with path 8/11 and only then it moves to path 0/9.

| state | Paths |
|---|---|
| qₐ | 0, 8 |
| q_{b} | 8/11, 0/19 |
| q_{c} | 0/3, 0/9, 8/9 |
| q_{d} | 8/11/12, 0/19/20 |
| qₑ | 8/11/14, 0/19/24 |

### Sort-Merge-Join of Partial Twig-Pattern Answers (Step 1325)

This section describes the actions in step 1325. These actions are common relational DB actions. The inputs are the partial twig-pattern answers of step 1315. The first action is sorting of the partial answers as shown in the table below. The second action is an operation of merge-join algorithm (for more details, see C. J. Date Introduction to Database System) on the sorted partial answers. The merge-join traverses all lists of records and joins paths with equal common path. In this way, three solutions are returned as answers for (qₐ, q_{b}, q_{c}, q_{d}, qₑ) are (0, 19, 3, 20, 24), (0, 19, 9, 20, 24) and (8, 11, 9, 12, 14).

| state | Paths |
|---|---|
| qₐ | 0, 8 |
| q_{b} | 0/19, 8/11 |
| q_{c} | 0/3, 0/9, 8/9 |
| q_{d} | 0/19/20, 8/11/12 |
| qₑ | 0/19/24, 8/11/14 |

### Results

The indexing algorithm was compared against the GW index, which is the most accurate non-holistic index. The data guide group together nodes which have the same labels on the path from the root. We tested indexing by using twig-patterns that were randomly generated to prune indexed data. We used three datasets in the experiments: TreeBank (Marcus, M., Santorini, B., Marcinkiewicz, M.: “Building a large annotated corpus of English: the Penn Treebank” in Computational Linguistics, vol. 19, pages. 297-352, 1993) XMark (A. R. Schmidt, M. L. Kersten, M. A. Windhouwer, F. Waas. Efficient Relational Storage and Retrieval of XML Documents. In International Workshop on the Web and Databases pages. 47-52, 2000) and DBLP (Michael Ley, Patrick Reuther: Maintaining an Online Bibliographical Database: The Problem of Data Quality. EGC pages 5-10, 2006). We considered two parameters: 1) accuracy. i.e. the percent of nodes that matched the twig-pattern out of the extracted nodes; and 2) coverage, i.e. the number of twig patterns the holistic index improves the accuracy. The experiment showed that the holistic index improves the accuracy in about 30% against the data guide. For more complex queries the improvement is even more evident. The holistic index can be up to ten times more accurate than the non-holistic data guide. The coverage for complex patterns is about 80%.

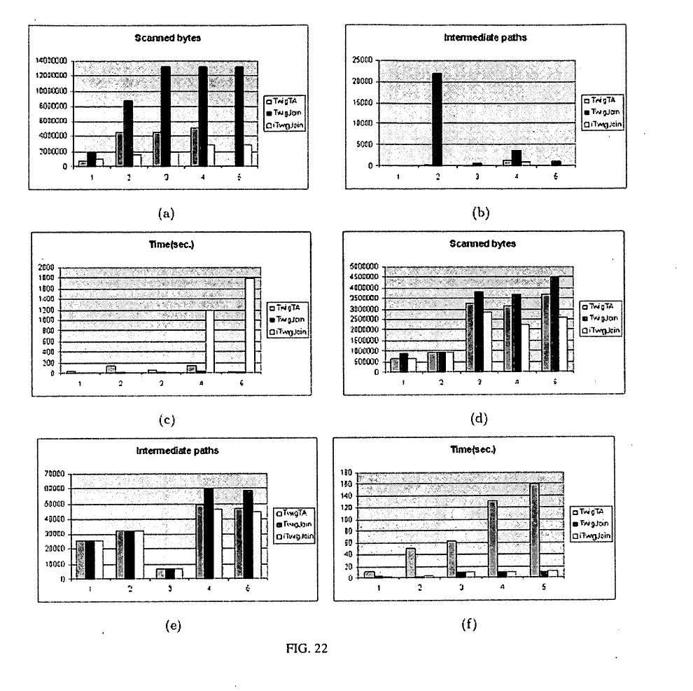

The join algorithm presented in this invention (denote by TwigTA hereinafter) was compared against TwigStack (see BKS) and iTwigJoin (see T. Chen, J. Lu, and T. W. Ling “On boosting holism in XML twig pattern matching using structural indexing techniques”, SIGMOD, pages 455-466, 2006) indexes. The TwigStack is the holistic join method that was first suggested. The iTwigJoin is a holistic join method that combines non-holistic indexing. We tested the join methods on the Treebank and XMark data sets. We consider the following performance metrics to compare between the performances of twig pattern matching algorithms which are based on three streaming schemes: 1) the number of extracted node records; 2) the number of produced intermediate paths; and 3) the running time. FIG. 22 compares the performance of these algorithms for XMark and Treebank datasets. We used a fixed set of five queries for each dataset.

As seen in FIG. 22, TwigTA prunes up to 30% of the number of the scanned records in the processing XMark dataset (FIG. 22(d)). iTwigJoin prunes 40% of the irrelevant data. In the processing of the Treebank dataset (FIG. 22(a)), we see that TwigTA prunes up to 99% of the irrelevant data. iTwigJoin prunes 77% of the irrelevant data. The 99% pruning is achieved for Treebnak5 query which does not returns any results. Because of its accuracy, TwigTA algorithm extracts only 8 nodes and filters the rest. When considering these results we need to remember that iTwigJoin uses index pre-processing to prune records. The TwigTA prunes records in the join operation without any index preprocessing. With respect to the numbers of intermediate paths output by the different algorithms, TwigTA avoids redundant intermediate paths that were produced by TwigStack. For the XMark dataset (FIG. 22(e)), the reduction ratio goes up to 25% (XMark5) and for Treebank (FIG. 22(b)) as high as 98:1 (Tree2). iTwigJoin reduction ratio goes up to 25% (XMark5) and for Treebank as high as 2750:1 (Tree2).

In terms of running time, For XMark (FIG. 22(f)), iTwigJoin is always faster than TwigStack. For Treebank (FIG. 22(c)), iTwigJoin is faster for a small number of streams. For large number of streams, the preprocessing of the structural-index can take about 30 minutes! In this case the preprocessing of the structural-index is taking more time than the query processing.

### Applications Examples

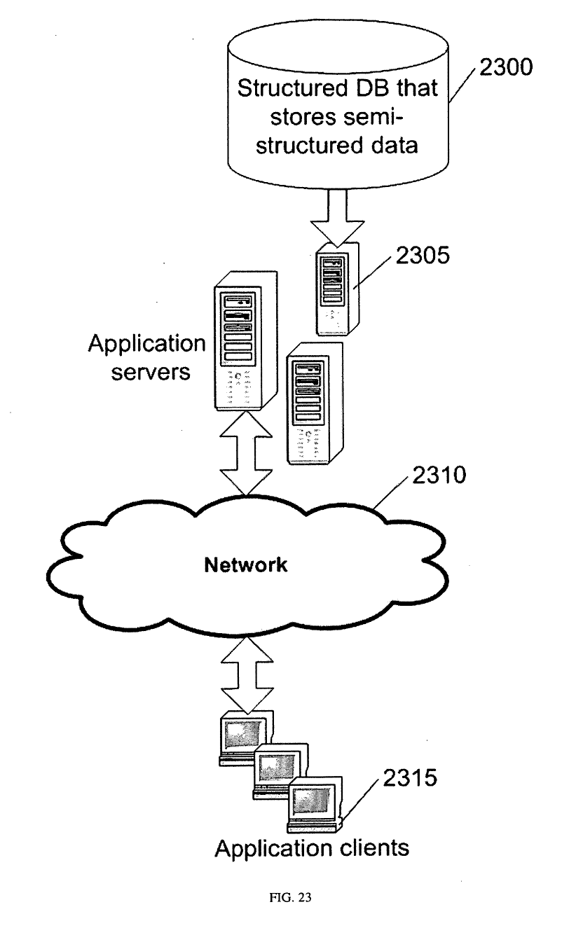

XML is a semi-structured textual data that has a tree model. All of the major suppliers of infrastructure products embrace XML and related standards as core technologies. The invention builds an infrastructure to implement XML across an enterprise and between organizations. Efficient storing and manipulation of terabytes of XML data becomes a critical task. This invention enables efficient query processing of XML data stored in a structured DB. Examples for XML applications where the invention is a major critical component in a system that implements it are given below. Most of the examples describe systems that have the general architecture of FIG. 23.

FIG. 23 shows a structured DB 2300 where semi-structured data is stored and where the structured DB can be a relational DB, a native DB, or an object-oriented DB as long as it stores the semi-structured data as described above. Application servers 2005 connect via networking between the structured DB 2300 and a network 2310. Clients and servers 2315 are connected to an application server 2305 via network 2310. The clients and the servers receive DB data via the application server.

### Publishing (Content Management)

XML has surpassed SGML as the preferred method of adding application- and vendor-neutral descriptive markup to documents. The publishing industry, which uses XML to separate between form and content, also uses databases to attach metadata to documents. Publishers use XML-based content management. The invention supports content-management products for multiple media, including WEB clients, mobile devices, CD-ROM and print. The semi-structured data model supplies the ability to describe and manipulate and store rich hierarchies of content. Access to a structured DB enables to attach attributes (known as metadata) to the stored semi-structured data nodes records.

Content-management servers (2305 in FIG. 23) typically wrap workflow, status tracking and library services around a database. Elements of these systems include integration with the authoring process, maintenance of folders and file abstraction, integrated repository functionality (including versioning), workflow integration, extensible metadata, and support for structured, semi-structured and full-text querying. Emerging content-management systems are also based on XML. The content-management uses a structured DB that stores both the content and the metadata (e.g. in (2300 in FIG. 23). The methods disclosed in the invention enable efficient content production. This is highly important if the data has to be delivered immediately, e.g. in news or in pricing stock market options. The content may be delivered from the content management systems using any Web transport protocols (FTP, HTTP and WebDAV).

### Messaging (Application-to-Application Communication)

XML is at the core of Web services. Protocols such as SOAP, XML-RPC, and JMS enable software components to communicate with each other via XML dialects. Messaging applications require high throughput, rapid generation and ingestion of messages, the ability to query message payloads, extensible attributes, integrated XSLT transformation capabilities, and interfaces with standard APIs. The invention supports these activities.

XML on a structured DB (2300 in FIG. 23) provides a native way to store messages by the terabyte. Generation and aggregation are handled via native structured DB operators running in the kernel. Semi-structure querying as described in the invention allows fast manipulation of messages. The application server (2305 in FIG. 23) may communicate with the WEB through JMS and SOAP interfaces. These features create a high-volume messaging server that can scale by the proposed invention to meet enterprise requirements.

### Business-to-Business Data Exchange (Next-Generation EDI)

XML is a low-cost replacement for electronic data interchange (EDI) implementations. Structured business documents, such as purchase orders and bill presentments, can be expressed as XML documents that can be delivered asynchronously and without the need for direct application-to-application integration, as was done with first-generation EDI implementations. In XML-based implementations, the systems are loosely coupled, rather than tightly integrated, because the data can be passed as an XML document that can be validated against a schema to ensure common definitions and enforce DOM fidelity (order of elements, namespaces, etc.) as well as to maintain fidelity to the original form of the data.

Structured DB (2300 in FIG. 23), which stores XML, addresses business-to-business interchange. It supports dynamic discovery of data structures through fast querying as suggested by the invention. A business application server (2305 in FIG. 23) provides API access for UDDI and WSDL. Applications requiring higher performance can rely on the fast query processing of the invention. The querying is also the core functionality for the transformations that are needed when mapping data from one schema to another.

### Business-to-Business Data Exchange Example—Supply Chain

Mass marketers such as WalMart use suppliers which have access to a WalMart database that stores the status of the merchandise items in WalMarts' 7000 stores. The merchandise data is stored as a semi-structured data in a structured DB (e.g. 2300 in FIG. 23). The semi-structured data makes it easy for Wall-Mart to update the merchandise item status, merchandise item prices, etc. The database access enables each WalMart supplier to retrieve semi-structured data on the merchandise items supplied by WalMart. The contracts between the suppliers and WalMart forces the suppliers to supply merchandise items before any of the 7000 stores runs out of such items. The suppliers can use any query on the semi-structured database to achieve this task. The query processing must retrieve the semi-structured data efficiently for queries with a complex structure on semi-structured data with Terabytes of data. Inefficient query processing would force the suppliers to supply more items than needed, because the data they retrieve from the DB is not “real time” due to the delay in the query processing. Therefore, inefficient query processing in such a situation would lead to significant monetary loss to a supplier. The suppliers may use the methods described herein to more efficiently obtain answers to queries in WalMart's database environment, thereby reducing and even averting losses.

e-Business (Tying Legacy Systems to Web Applications through XML)

Increasingly, XML is being used as “glue” to bind legacy software applications to e-business front ends that deliver information to customers over the Web. A typical scenario is to transform the data in the legacy application to XML in order to hand it off to the new e-business application. As e-business projects grow in complexity, developers will want support for generating XML views over relational and other existing data. To be done efficiently, such application development requires integration with adaptors or gateways to create normalized XML views over multiple structured and semi-structured data.

Storing semi-structured data in structured DB (e.g. 2300 in FIG. 23) makes it much easier to create XML views of mixed content stored in the database or accessed from other servers via gateways. It also opens up its repository to Web protocols and, by simplifying the process of linking information in the database to external sources around the world.

e-Government

Different database programs are a major problem in e-government projects in many countries. Consider, for instance, accessing a governmental portal in order to use a particular service (2315 in FIG. 23).

Although one may have entered the e-government website via a single portal, behind the scenes the data required for these activities will typically be held in several different proprietary database systems. This is because of the long history of piecemeal implementation of databases in local government. Typically there will be no common standard for coding the data fields in these databases. For example, in one system, addresses might have fields with names such as House number, Street name, Town, City, Postcode and so on. Another system might have Address1, Address2, and Address3 instead. This is an example of the “legacy problem”. In many cases, it is too expensive to replace these diverse systems with new, integrated systems operating on common standards. Somehow, the older systems have to be incorporated into the newer e-government systems and have to be able to work together with them. A vital tool for enabling these diverse systems to work together has been XML. Fast querying of XML that is stored on structured DB enables solution to these problems. The data from these systems can be migrated into XML and stored as semi-structured data. The semi-structured data along with fast query processing that this invention enables produce a reliable e-government application.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein. For example, any digital computer system can be configured or otherwise programmed to implement the methods disclosed herein, and to the extent that a particular digital computer system is configured to implement the methods of this invention, it is within the scope and spirit of the present invention. Once a digital computer system is programmed to perform particular functions pursuant to computer-executable instructions from program software that implements the present invention, it in effect becomes a special purpose computer particular to the present invention. The techniques necessary to achieve this are well known to those skilled in the art and thus are not further described herein.

Computer executable instructions implementing the methods and techniques of the present invention can be distributed to users on a computer-readable medium and are often copied onto a hard disk or other storage medium. When such a program of instructions is to be executed, it is usually loaded into the random access memory of the computer, thereby configuring the computer to act in accordance with the techniques disclosed herein. All these operations are well known to those skilled in the art and thus are not further described herein. The term “computer-readable medium” encompasses distribution media, intermediate storage media, execution memory of a computer, and any other medium or device capable of storing for later reading by a computer a computer program implementing the present invention.

Accordingly, drawings, tables, and description disclosed herein illustrate technologies related to the invention, show examples of the invention, and provide examples of using the invention and are not to be construed as limiting the present invention. Known methods, techniques, or systems may be discussed without giving details, so to avoid obscuring the principles of the invention. As it will be appreciated by one of ordinary skill in the art, the present invention can be implemented, modified, or otherwise altered without departing from the principles and spirit of the present invention. Therefore, the scope of the present invention should be determined by the following claims and their legal equivalents.

All patents, patent applications and publications mentioned in this specification are herein incorporated in their entirety by reference into the specification, to the same extent as if each individual patent, patent application or publication was specifically and individually indicated to be incorporated herein by reference. In addition, citation or identification of any reference in this application shall not be construed as an admission that such reference is available as prior art to the present invention.

1. A computer implemented method for obtaining answers to queries in a database environment, comprising the steps of:
a) forming tree automata (TA);
b) processing semi-structured data stored in a database the processing based on the TA to provide indexed data;
c) pruning the indexed data to obtain pruned data; and
d) joining either the pruned data or the semi-structured data to provide the answers to the queries.

2. The method of claim 1, wherein the step of forming tree automata includes forming unordered TA.

3. The method of claim 1, wherein the step of processing semi-structured data based on the TA to provide indexed data includes using a structural index for a structure criterion of a query.

4. The method of claim 1, wherein the step of pruning the indexed data to obtain pruned data includes holistic pruning of the indexed data.

5. The method of claim 4, wherein the holistic pruning includes holistic selection of states from a tree automaton that describes the semi-structured data.

6. The method of claim 1, wherein the step of joining the pruned data to provide the answers to queries includes performing a structural join applied to a structure criterion of a query.

7. The method of claim 6, wherein the step of joining the pruned data to provide the answers to querries further includes performing a holistic join on the pruned data.

8. The method of claim 7, wherein the holistic join is based on a holistic selection of states from a tree automaton that describes the semi-structured data.

9. The method of claim 1, wherein the semi-structured data includes merchandise data.

10. The method of claim 1, wherein the queries are received from an entity selected from the group consisting of a client and an application.

11. The method of claim 1, wherein the semi-structured data is XML data.

12. The method of claim 1, wherein the queries are twig-patterns.

13. A computer implented method for obtaining answers to queries in a database environment, comprising the steps of:
a) forming tree automata (TA); and
b) using the TA, joining semi-structured data stored in a database to provide the answers to the queries.

14. The method of claim 13, wherein the step of forming tree automata includes forming unordered TA.

15. The method of claim 13, wherein the semi-structured data includes merchandise data.

16. The method of claim 13, wherein the queries are received from an entity selected from the group consisting of a client and an application.

17. The method of claim 13, wherein the semi-structured data is XML data.

18. The method of claim 13, wherein the queries are twig-patterns.
